(19) United States
(12) Patent Application Publication
(10) Pub. No.: US 2025/0248391 A1
(43) Pub. Date: Aug. 7, 2025

(54) VIABLE VITREOUS GRAFTS FOR PRESERVATION AND RECOVER OF TISSUE FOR TRANSPLANT AND CLINICAL USE

(71) Applicant: Clemson University Research Foundation, Clemson, SC (US)

(72) Inventors: Shangping Wang, Mount Pleasant, SC (US); Hai Yao, Mount Pleasant, SC (US); Yongren Wu, Charleston, SC (US); Peng Chen, Charleston, SC (US)

(21) Appl. No.: 19/045,945

(22) Filed: Feb. 5, 2025

Related U.S. Application Data
(60) Provisional application No. 63/549,834, filed on Feb. 5, 2024.

(51) Int. Cl. A01N 1/162; A01N 1/125

(52) U.S. Cl. CPC A01N 1/162; A01N 1/125

(57) ABSTRACT

A system and m ethos for vitrification by transitioning tissues into a vitreous state at cryogenic temperatures and protecting them from ice crystal damage using high concentrations of cryoprotectant agents (CPAs). This system balances penetration and reducing cell toxicity. The system and method use a simulation-based optimization approach developed by combining computational modeling with microcomputed tomography imaging to predict three-dimensional CPA distributions within tissues over time accurately. In one embodiment, CPA exposure time was minimized, resulting in 85% viability in 4-ml meniscal specimens, 70% in 10-ml whole knee menisci, and 85% in 15-ml whole TMJ menisci (i.e., TMJ disc) post-vitrification, outperforming slow-freezing methods (20%-40%). Vitreous meniscus grafts demonstrated clinical-level viability (≥70%), closely resembling the material properties of native tissues, with long-term availability for transplantation.

### FIELD OF THE INVENTION

The present methods, techniques and systems broadly relate to a cryopreservation process, and more particularly, to a method and system for viable vitreous grafts for preservation and recover of tissue for transplant and clinical use to minimize cell damage resulting from intercellular and extracellular ice formation and solute effects that arise during traditional cryopreservation process. This system is beneficial for the preservation and restoration of avascular tissues.

### BACKGROUND

Cryopreservation is a process used to stabilize biological materials at very low temperatures. Previous attempts to preserve and store biological materials, such as living cells often results in a significant loss of cell viability and in some cases as much complete loss of cell activity and viability.

Damage to cells during these storage techniques can occur when there is intracellular ice formation during freezing step or during subsequent recrystallization. Certain cooling often causes the formation of more intracellular ice since water molecules are not fully migrated out of the cell during the short timeframe associated with the rapid cool-down rates. Intercellular ice formation also can arise during recrystallization that occurs during the warming or thawing cycles. If too much water remains inside the living cell, damage due to initial ice crystal formation during the rapid cooling phase and subsequent recrystallization during warming phases can occur and such damage is usually lethal to the cells.

In certain areas, there is a shortage of viable tissue for transplant and grafts as certain tissues (e.g., avascular) cannot be properly preserved. The shortage of suitable donor meniscus grafts for certain tissues impedes treatments for millions of patients. For example, knee and temporomandibular joint (TMJ) are difficult to properly preserve so that they can be used for graphs, transplants and the like. While technologies such as vitrification has some benefits by transitioning tissues into a vitreous state at cryogenic temperatures, protecting them from ice crystal damage using high concentrations of cryoprotectant agents (CPAs) is an area that needs improvement. Further, the vitrification's success is hindered for larger tissues (>3 ml) due to challenges in CPA penetration.

Dense avascular meniscus tissues require extended CPA exposure for adequate penetration; however, prolonged exposure becomes cytotoxic creating technological challenges in the preservation and restoration of these tissues. A system that can balance penetration and reducing cell toxicity would be advantageous.

Musculoskeletal tissue transplantation plays a pivotal role in orthopedic and reconstructive surgeries, especially in preserving the whole tissue structure and function, which significantly enhances the quality of life for patients. However, the limited availability of suitable tissue replacements presents substantial challenges in advancing surgery technology and achieving favorable post-transplantation clinic outcomes. This challenge is particularly acute in the context of interpositional fibrocartilaginous meniscus replacement in the knee joint (knee meniscus) and temporomandibular joint (also known as the TMJ disc).

In the United States, more than one million patients with meniscus injury undergo surgical repair or meniscectomy each year. Currently, meniscal allograft transplantation (MAT) involving human cadaver tissue is typically indicated for patients with symptomatic subtotal or total meniscectomy knees. Despite MAT being performed worldwide and yielding favorable long-term outcomes, its widespread clinical adoption has faced significant constraints. During the period from 2007 to 2011, there were 3,295 MATs performed in the US. This limitation primarily stems from challenges associated with shortage of available donor meniscal allografts. Consequently, this situation significantly increases the incidence of the risk of joint issues later in life by elevating joint contact stress.

A similar striking issue is found in patients suffering from TMJ disorders (TMD). Over 10 million TMD patients experience TMJ disc degeneration and mechanical dysfunction, leading to surgery in 10% of these cases. Although disc discectomy has been used in clinical practice for decades, it often yields unsatisfactory treatment outcomes, such as severe osteoarthritis and joint ankylosis. Surprisingly, the potential of using a TMJ disc allograft from a donor has remained largely unexplored due to its limited availability, despite promising results emerging from animal studies. This lack of research on donated TMJ disc allografts has forced the use of replacement autografts, such as a temporalis muscle fascia flap and abdominal fat autograft, or alloplastic total joint replacement. This reliance on autografts results in pain and functional loss, additional surgical sites, prolonged recovery times and elevated risk of surgical site infections, while alloplastic total joint replacement has shown disadvantages for long-term use, particularly in children, as they may hinder the normal growth of the facial skeleton and require replacement upon reaching facial maturity. Therefore, there is an urgent need to address the shortage of donors and provide off-the-shelf availability of grafts that possess natural properties closely resembling those of the native tissues.

In some cases, fresh-frozen and cryopreserved allografts are used as valuable alternatives for transplantation when fresh donor grafts are unavailable. These grafts provide essential support for patients with immediate needs. However, achieving favorable long-term clinic outcomes still presents challenges due to their limitations in preserving viable cells. The formation and growth of ice crystal formation during fresh-freezing and cryopreservation (i.e. slow-freezing) processes result in substantial cell loss. Within a healthy meniscus is has been shown that fibrochondrocytes plays a vital role in synthesizing and maintaining the extracellular matrix, which is responsible for its distinctive material and structural properties.

Clinical outcomes have further demonstrated that MAT using fresh meniscus allografts yields superior pain relief, enhanced function and a lower failure rate compared to MAT using frozen grafts. In some animal transplantation studies involving conventionally cryopreserved meniscal allografts, while cryopreservation did not appear to affect the morphological appearance or biomechanical properties of menisci, biosynthetic activity was decreased to less than 50% of normal control values, with only 10% of transplanted meniscal cells displaying metabolic activity. Additionally, as another vital tissue in the effort to maintain knee joint health and function, alongside the meniscus, donor articular cartilage necessitates the presence of viable chondrocytes, as demonstrated by Cook's research group. Their findings indicate that viable donor chondrocytes in osteochondral allografts (with viability that can exceed 70% at the time of transplantation) primarily contribute to preserving the health of donor articular cartilage over the long term. Therefore, to maximize the chances of long-term allograft survival, it is desirable to manipulate storage conditions to minimize fibrochondrocyte death. It would be advantageous to have a system that uses innovative preservation methods for viable allografts to enhance long-term clinical outcomes post transplantation.

In some cases, vitrification looks to hold promise in addressing tissue shortages, but its feasibility in maintaining a viable knee meniscus or TMJ disc has yet to be provided.

As stated, the shortage of suitable donor grafts from the knee and temporomandibular joints (TMJ) impedes treatments for millions of patients. To address this challenge, fresh-frozen and cryopreserved allografts are currently used as valuable alternatives for transplantation when fresh donor grafts are unavailable. These grafts provide essential support for patients with immediate needs. However, achieving favorable long-term clinic outcomes still presents challenges due to their limitations in preserving viable cells. The formation and growth of ice crystal formation during fresh-freezing and conventional cryopreservation (i.e. slow-freezing) processes result in substantial cell loss, leading to unfavorable long-term clinic outcomes. Therefore, we have advanced the development of vitreous grafts for knee menisci, osteochondral allografts, and TMJ discs. These grafts are created by transitioning donor tissues in to an amorphous solid vitreous state during cooling, effectively preventing ice crystal formation at cryogenic temperatures, with the aid of high concentration cryoprotective agents (CPAs). This process, also known as vitrification, is used for the first time in these three specific tissue types. The complete vitrification procedure typically involves selecting appropriate CPAs, adding CPA s to the tissues, cooling, storage, warming, removing CPAs from the tissues, and tissue recovery. Our invention involves optimizing each step of this process to develop the optimal preservation protocol for each specific tissue type.

### DESCRIPTION OF THE DRAWINGS

FIG. 1A shows meniscal specimens harvested from the central region of a meniscus according to the present invention;

FIG. 1B shows viability of vitrified samples was improved by extending CPA loading time according to the present invention;

FIG. 1C shows a simulation model used to investigate CPA diffusion kinetics within meniscal tissues according to the present invention;

FIG. 1D shows the penetration of CPAs throughout the whole meniscus and TMJ disc was predicted and used for vitrification according to the present invention;

FIG. 1E shows vitrified samples being placed in vitrification and storage according to the present invention;

FIG. 1F shows vitrified samples after convectional warming according to the present invention;

FIG. 1G shows the whole knee meniscus including anterior horn (a), central (c), and posterior horn (p), and the whole TMJ disc including anterior (a), central (c), posterior (p), medial (m), and lateral (I), analyzed for viability, metabolic activity, histological analysis, and mechanical properties;

FIG. 2A shows images having meniscal viability and metabolic activity assessed by fluorescence live/dead imaging and Alamar Blue assays including fresh, slow-frozen (SF), and vitrified meniscal specimens (1 mm and 3.5 mm thick) wherein each 3.5 mm specimen's sagittal section is represented through three images: top, middle, and bottom, and the groups include fresh, SF, vitrified after the 1.5-hour CPA (e.g., VS55) loading (1.5 Hr Vit), 3-hour CPA loaded and unloaded without vitrification (3 Hr CPA), and vitrified after the 3-hour CPA loading (3 Hr Vit), and wherein scale bars represent 200 μm;

FIG. 2B shows a chart of cell viability quantified in the middle images of 3.5 mm specimens from fresh (N=n=5) and preserved groups at day 0 post-warming including SF (N=n=4), 1.5 Hr Vit (N=n=6), 3 Hr CPA (N=n=3), and 3 Hr Vit (N=n=4). p-value was determined with a two-sided t-test;

FIG. 2C shows a chart of metabolic activity in 1 mm and 3.5 mm thick vitrified tissues compared to SF 3.5 mm thick tissue and the fresh 3.5 mm thick control group, over 0 to 4 days post-warming, the results are normalized to respective specimens (N=3-4; n=6-12) before CPA loading, and results from fresh control samples are normalized to their average values on day 0 (N=3; n=8), and a black dashed line at 100% recovery indicates cell metabolic activity of fresh meniscal specimens, N=number of independent menisci; n=number of specimens. p-value determined via two-way ANOVA, Data are mean+SD;

FIG. 3A shows CPA concentration profiles within meniscal specimens using a uCT imaging-based simulation method including scanned transverse section (green area in the insert figure) at half thickness with the calibration curve for meniscal specimens equilibrated in different CPA solutions (N=3, n=12 for samples equilibrated in 0% VS55; N=n=3 for other conditions);

FIG. 3B shows pseudocolor uCT images of meniscal tissues equilibrated in different concentrations of CPA solutions;

FIG. 3C shows a pseudocolor uCT image (left) alongside a computational image (right) of a 3.496 mm thick CPA-loaded sample;

FIG. 3D shows concentration profiles of the same CPA loaded sample using both computational modeling and the uCT curve, with a best-fit diffusivity value of 4.6×10-10 m2/s (R2=0.9696);

FIG. 3E shows diffusivity values of CPA at 0° C. (N=3; n=9) and 22° C. (N=3; n=6) with a two-sided t-test for significance, data are meant SD;

FIGS. 3F and 3G shows panels depicting CPA distribution after loading samples of varying thicknesses and loading times at 0° C., solid lines represent experimental conditions for viability assessment, and dashed lines represent simulated conditions;

FIG. 3H shows representative validation of CPA distribution in a 3.443 thick meniscal specimen after a 1-hour stepwise loading period (10 min each step) at 0° C. using modeling (D=3.82×10⁻¹⁰ m2/s), N=number of independent menisci, n=number of specimens;

FIG. 4A shows a simulation and uCT-validation of CPA distribution in the whole meniscus and TMJ disc including a simulation for CPA concentration through a 3D whole meniscus model after 3-hour CPA loading (left), its transverse sections at half thickness from the model (middle) and experimental uCT data (right);

FIGS. 4B and 4C show concentration profiles (black lines) on both transverse and sagittal sections of the anterior (A), central (C), and posterior (P) horns, respectively, and simulated profiles after 120-min (red), 180-min (blue), and 240-min (green) loading periods using modeling (D=3.82×10⁻¹⁰ m2/s), and experimental uCT data (black circle with line) after a 180-min CPA loading align well with simulation data, and the x-axis represents the distance normalized by its actual length;

FIG. 4D shows a simulation for CPA concentration through a 3D whole TMJ disc model after 3-hour CPA loading (left), Red dashed area in the inferior view (left top) represents the TMJ disc: anterior (A), central (C), posterior (P), medial (M), and lateral (L), and Sagittal sections of three bands (A-M-P, A-C-P, and A-L-P) represent CPA concentrations with average values of 82.22%, 82.20% and 82.29% respectively (right);

FIG. 4E shows CPA concentrations from uCT data across TMJ discs (N=3, n=9 for each region; N=3, n=45 for whole disc average) after 3-hour loading, N=number of independent discs, n=number of measurements, and no significance in different regions observed using a one-way ANOVA, data are mean+SD;

FIG. 5A shows viability and metabolic activity of vitrified vs fresh and slow-frozen menisci including transverse sections at half thickness show fresh (a, e, i, m), slow-frozen (b, f, j, n), 2-hour vitrified (c, g, k, o), and 3-hour vitrified (d, h, I, p) menisci. Images (a-d) are 2× objective magnification and stitched together. Images of regions (e-p) within dashed boxes (red=anterior (A), blue=central (C), and yellow=posterior (P)) presented at 10×. Scale bars: 2 mm (a-d), 200 μm (e-p);

FIG. 5B shows cell viability from fresh (N=4), slow-frozen (N=3), 2-hour vitrified (N=3), and 3-hour vitrified (N=3) menisci. p-value determined with two-way ANOVA with Bonferroni post-hoc test;

FIG. 5C shows cell viability quantified in outer (grey), middle (red), and inner (blue) layers within sagittal sections. No significant differences within layers of each group using two-way ANOVA with Bonferroni post-hoc test;

FIG. 5D shows metabolic activity between vitrified menisci for fresh (N=3; n=11), 2-hour (N=3; n≥10) and 3-hour (N=4; n≥11) durations, along with SF menisci (N=3; n≥11), over 0 to 4-day post warming. Metabolic activity normalized to corresponding average fresh meniscus values on day 0 within the same batch. N=number of independent menisci; n=number of sagittal sections. p-value determined via two-way ANOVA. Data are mean+SD;

FIG. 6A shows viability and metabolic activity of 3-hour vitrified vs fresh and slow-frozen whole TMJ discs including Sagittal section of anterior (A), central (C), posterior (P), medial (M), and lateral (L) for fresh, slow-frozen (SF), and 3-hour vitrified (3 Hr Vit) TMJ discs. The whole anterior-posterior band images captured via 2× magnification and manually stitched together. Scale bars represent 3 mm. Five specific region views were captured via 10× magnification. Scale bars represent 200 μm. The region views for anterior (red), central (blue), and posterior (yellow) align with locations shown within the anterior-posterior bands through dashed boxes;

FIG. 6B shows quantitative viability analysis and comparison of five distinct regions obtained from three groups (N=4). p-value determined via two-way ANOVA with Bonferroni post-hoc test;

FIG. 6C shows metabolic activity comparison over a 4-day post-warming period in fresh, slow-frozen and 3-hour vitrified whole TMJ discs compared to their respective fresh values (N=4). p-value determined using two-way ANOVA. Data are mean±SD. N=number of independent TMJ discs;

FIG. 7A shows representative histological images and mechanical properties of whole menisci including representative transverse sections with anterior horn (A), central (C), and posterior horn (P) stained with H&E, Safranin O, and Sirius red for fresh, slow-frozen (SF), 2-hour vitrified (2 Hr Vit), and 3-hour vitrified (3 Hr Vit). Magnification: 2×. Scale bars represent 5 mm;

FIGS. 7B, 7C and 7D shows corresponding brightfield images are at 20× with 200 μm scale bars. The polarized light images, along with their corresponding brightfield counterparts, were captured at 20× with 200 μm scale bars;

FIGS. 7E and 7F show equilibrium contact modulus (E) and permeability (F) of the superficial layer in three regions for fresh (N=6; n≥14), SF (N=3; n≥6), 2-hour vitrified (N=3; n≥7), and 3-hour vitrified (N=5; n≥12) menisci, obtained through microindentation tests. N=number of independent menisci; n=number of measurements of all samples in each region. p-value determined with a two-sided t-test. Data presented as the mean±SD;

FIG. 8A shows representative histological images and mechanical properties of whole TMJ discs including representative sagittal sections incorporating anterior (A), central (C), and posterior regions (P) stained using H&E, Safranin O, and Sirius red, are displayed for fresh, slow-frozen (SF), and 3-hour vitrified (3 Hr Vit). Magnification: 2×. Scale bars represent 2 mm;

FIGS. 8B, 8C and 8D show the corresponding magnified views of the anterior (B), central (C), and posterior regions (D) displayed at 20× magnification with 200 μm scale bars. The polarized light images, along with their corresponding brightfield counterparts, were captured at 20× with 200 μm scale bars;

FIGS. 8E and 8F show location-dependent equilibrium contact modulus (E) and permeability (F) of the superficial layer for fresh (N≥3; n=59 total), SF (N≥3; n=23 total), and 3-hour vitrified TMJ discs (N≥3; n=26 total), obtained through microindentation tests. p-value determined with a two-sided t-test. N=number of independent TMJ discs; n=number of measurements. Data are mean±SD;

FIG. 9 through 16 illustrate testing and example of the system, methods and aspects and results of the invention;

FIG. 17A illustrates a graph of aspects of results of the system;

FIG. 17B illustrates images of application of the system;

FIG. 18A illustrates images of application of the system;

FIG. 18B illustrates a graph of aspects of results of the system;

FIG. 19A illustrates images of application of the system; and,

FIG. 19B illustrates a graph of aspects of results of the system.

### DESCRIPTION OF THE SYSTEM

This system accomplishes the advantages and goals of the above by providing a simulation-based optimization approach developed by combining computational modeling with microcomputed tomography (uCT) imaging to predict three-dimensional CPA distributions within tissues over time accurately. This approach minimized CPA exposure time, resulting in increased viability in 4-ml meniscal specimens (e.g., an increase of 80% or more), 10-ml whole knee menisci (e.g., an increase of 60% or more), 15-ml whole TMJ menisci (i.e., TMJ disc) (e.g., an increase of 80% or more) post-vitrification. This system can outperform traditional slow-freezing methods with improvements that can range from 20% to 40%. Further, this system allows for the extracellular matrix (ECM) structure and biomechanical strength of vitreous tissues to remain largely intact. Vitreous meniscus grafts demonstrated clinical-level viability that can achieve approximately 70% or greater, closely resembling the material properties of native tissues, with long-term availability for transplantation. The system can provide enhanced vitrification technology and provide new possibilities for other avascular grafts.

This system pioneers the development of vitreous grafts for tissues including knee meniscus and TMJ disc replacement. These grafts can be created by transitioning donor tissues into an amorphous solid vitreous state during cooling, effectively preventing ice crystal formation at cryogenic temperatures, with the aid of high concentration cryoprotective agents (CPAs). This process, also known as vitrification, has been demonstrated in small volumes (e.g., ≤3 ml) of vascularized tissues with thin and permeable extracellular matrix (ECM) structure, such as heart valve tissue samples and rabbit vein rings, with the aid of a 55% CPA solution that can include 8.4 M mixture of 1,2-propanediol, formamide, and dimethyl sulfoxide in Euro-Collins (EC) solution.

To address the scaling up to larger-sized tissues (e.g., ≥3 mL), this system provides regulating CPA loading periods, as it requires achieving adequate penetration within a limited exposure time, driven by the need to minimize CPA toxicity. This system assists with the challenges associated with avascular fibrocartilaginous tissues like knee menisci and TMJ discs. In contrast to vascularized tissues with thin and permeable tissue structures that facilitate CPA distribution through diffusion and convection, meniscus and TMJ disc tissues are dense and thick with restrictive permeability. These tissues depend exclusively on diffusion to achieve adequate CPA penetration, necessitating prolonged exposure times to enable deep CPA diffusion. However, prolonging exposure times carries the risk of increased CPA-induced cytotoxicity. Hence, this system optimizes CPA diffusion by extending the diffusion time within permissible limits, while minimizing toxicity, becomes of paramount importance.

This system uses CPA (VS55 in one case and VS55 with additives in another case) diffusion in avascular fibrocartilaginous tissues to optimize CPA loading time while minimizing cytotoxicity, employing a computational simulation approach. Knee menisci and TMJ discs loaded with adequate and toxically tolerable CPAs can achieve clinical-level viability (e.g., ≥70%), maintain integral ECM structure, and preserve biomechanical functions through vitrification, when compared to fresh tissues.

This system can provide enhanced CPA penetration within tissues by extending the CPA loading period that can be a crucial step for achieving optimal outcomes.

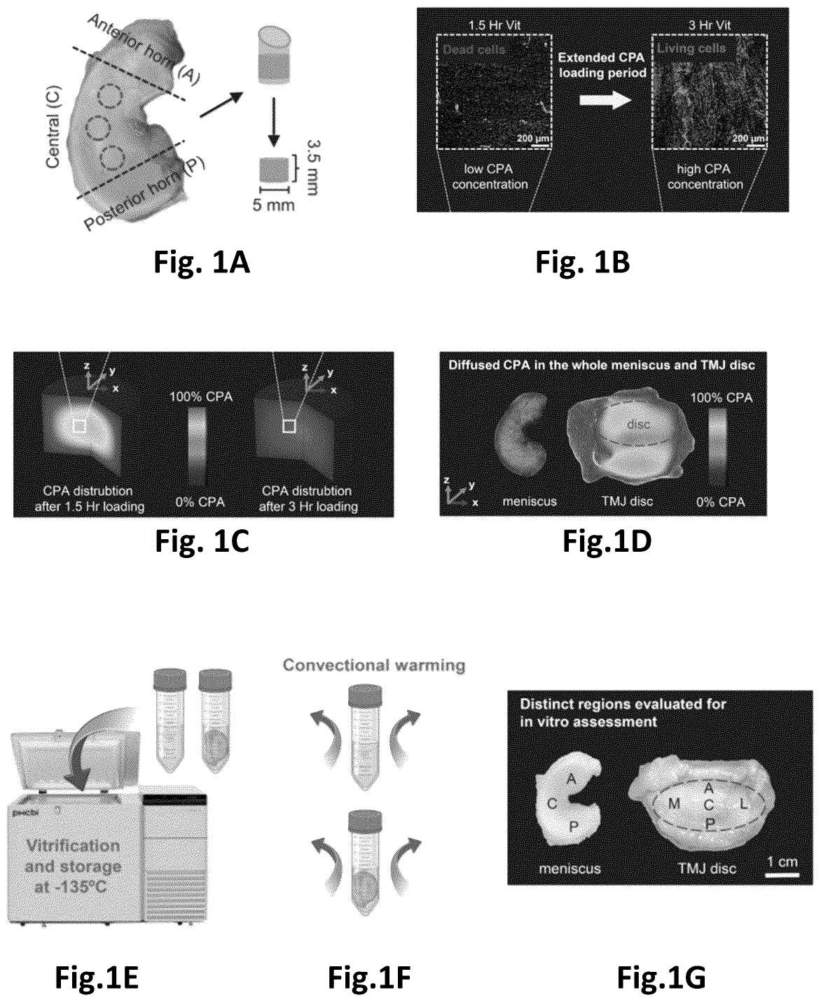

Referring to FIGS. 1A and 1G, this system uses a computational model that combines micro-computed tomography (uCT) imaging to delve into the intricate mechanism of CPA diffusion within meniscal tissues. This system also can apply to the whole knee menisci and TMJ discs. This system represents a leap in cell viability and ECM material properties for whole knee menisci and TMJ discs grafts, which was not feasible with previous approaches or with the traditional technologies. The vitrification approaches used by this system can be applied to design CPA loading protocols for other dense avascular tissue grafts, offering a promising solution to the shortage of donor tissues in transplantation.

To determine the success that this system provides and the relationship between diffused CPA concentration and tissue viability following vitrification, meniscal specimens (e.g., 5 mm diameter) of two different thicknesses were used (e.g., 1 mm and 3.5 mm). In one embodiment, each specimen was loaded with CPA in several steps, for a duration of in the range of 1.0 to 2.0 hours. and vitrified in a 20-ml glass vial containing 4-ml CPA supplemented with 0.3M sucrose and 0.3M trehalose. Successful vitrification was achieved by cooling from an initial temperature in the range of 20° C./min to 30° C./min down to a temperature in the range of −90° C. to −110° C. The next step can include a slower cooling within a range of 2° C./min to 5° C./min, to the lower temperature such as in the range of −90 to −140° C. This process resulted in the formation of a transparent glassy state around the sample. During the conventional warming, samples were rapidly warmed to a temperature in the range of −45° C. −25° C. at a rate in the range of 40° C./min to 70° C./min in a water bath. The water bath can be at a temperature in the range of 30° C. to 50° C.

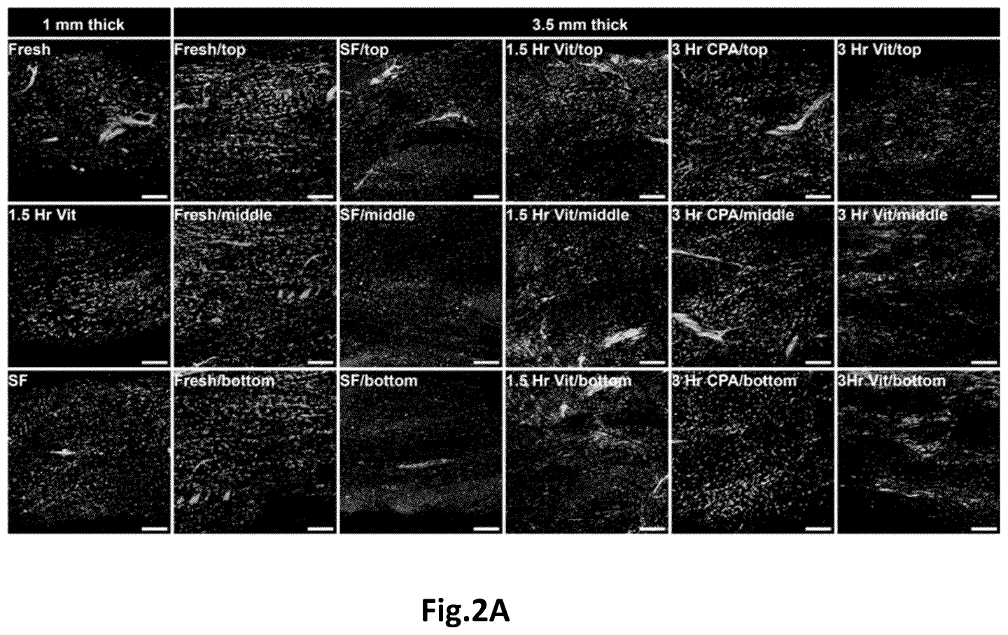

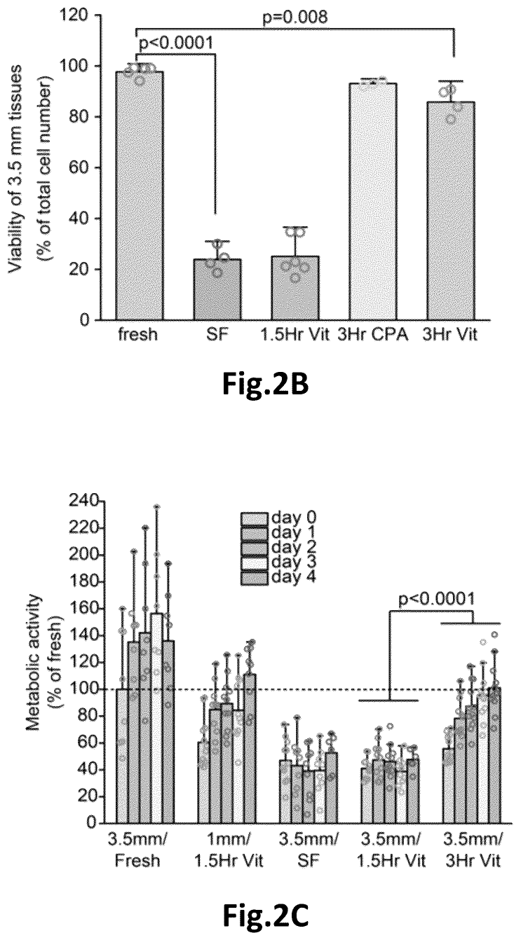

Referring to FIG. 2A, a vitrified 1 mm thick tissue was used to test this system and served as a smaller volume control group. This sample exhibited preserved living cells comparable to fresh samples, whereas the slow-frozen tissues showed a severe reduction in cell viability. However, as the thickness increased to 3.5 mm, both vitrification and slow freezing resulted in a decline in cell viability. Nonetheless, when the loading time was extended to 3 hours, the vitrified 3.5 mm thick tissues maintained living cells throughout their full thickness. These findings show improvements in the technology and that viability of vitrified samples depends highly on the concentrations of diffused CPAs. When an adequate concentration of CPAs is diffused throughout the samples, vitrification proves superior to slow freezing in preserving living cells. Referring to FIG. 2B, quantification analysis of cell viability for the 3.5 mm thick tissues shows that no adverse toxic effects from the 3-hour CPA exposure prior to vitrification. After vitrification, a viability rate in the range of 75% to 95% was achieved, whereas slow freezing preserved only about 24% of living cells, and 1.5-hour vitrified samples exhibited a viability of about 25%.

The metabolic activity of the tissues from day 0 to day 4 after warming improved as shown in FIG. 2C. Specifically, the 1 mm vitrified samples following 1.5-hour CPA loading, and the 3.5 mm vitrified samples following 3-hour CPA loading, exhibited a continuous recovery in metabolic activity over time, ultimately recovering completely by day 4 post-warming. This phenomenon was not observed in slow-frozen samples or 3.5 mm vitrified samples after 1.5-hour CPA loading. Therefore this system uses pCT-based simulation and can predict CPA distribution in menisci and TMJ discs.

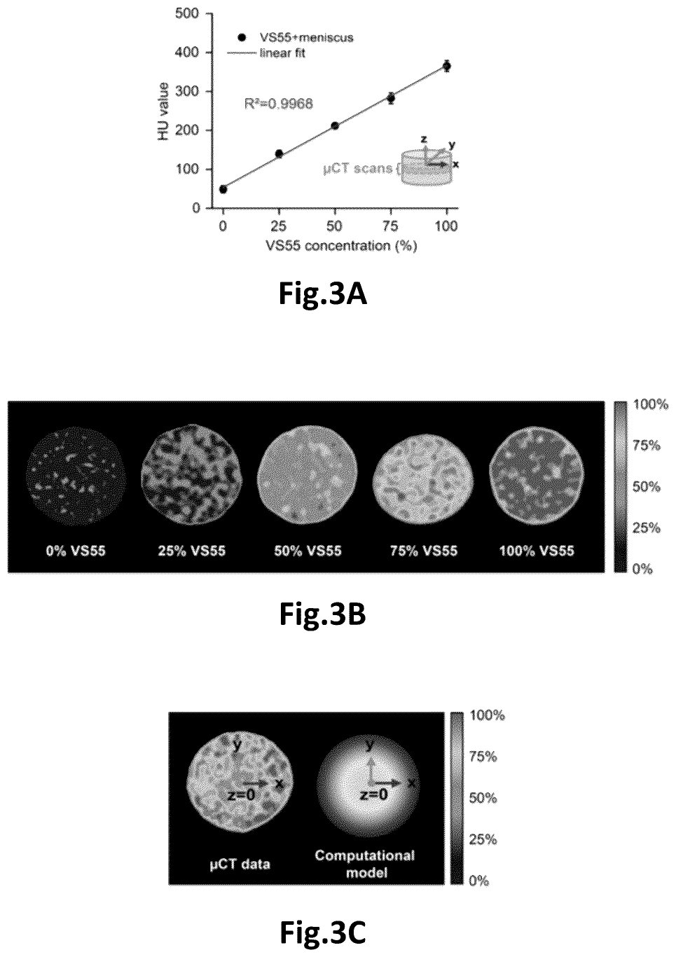

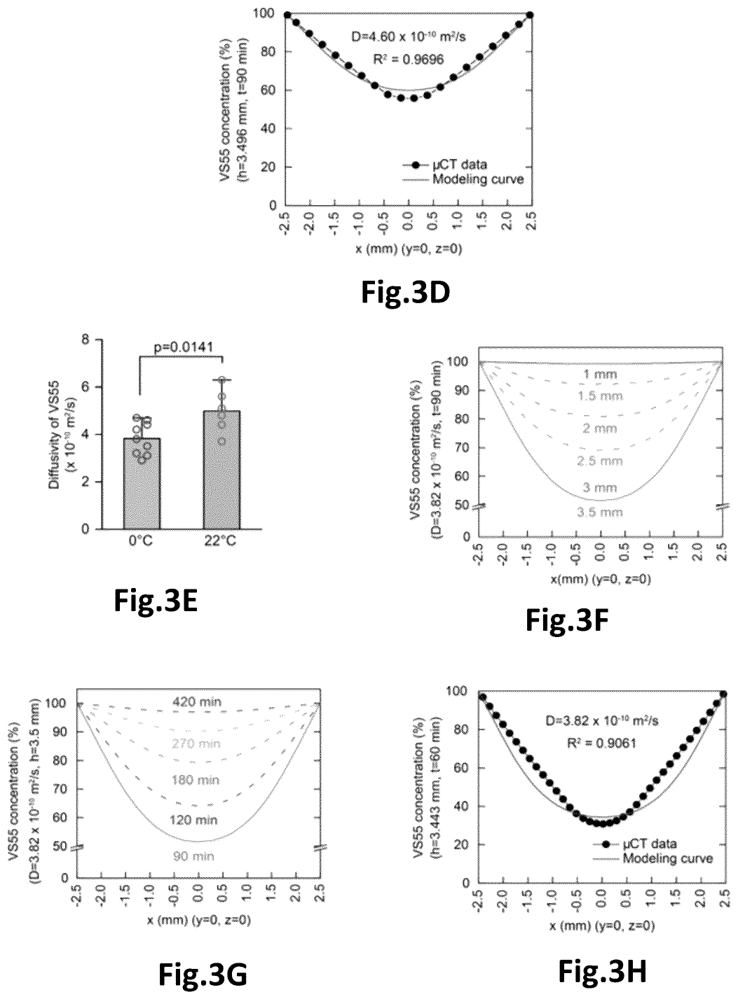

Referring to FIG. 3A through 3H, and in one embodiment, the determination of CPA diffusion, CPA concentration and distribution within the 3.5 mm thick meniscal specimens were determined using uCT imaging. The calibration curve of meniscal specimens equilibrated in different CPA solutions (e.g., VS55) concentrations is shown in FIG. 3A. A shown there is a linear correlation (e.g., R2>0.99) between Hounsfield Unit (HU) values and the corresponding CPA concentrations, providing a basis for determining CPA concentration within the tissue.

Referring to FIG. 3B, pseudo color images of CPA equilibrated meniscal tissues exhibited uniform HU values throughout the meniscal tissues. Based on the linear relationship between HU values and CPA concentrations, the CPA concentration in meniscal tissues after a 1.5-hour loading period can be determined from ρCT data using this system. Referring to FIG. 3C, the pseudo color and the computational modeling images of a CPA loaded sample shows higher CPA concentration at the edges and lower concentration in the center area of the sample. Referring to FIG. 3D, the concentration profiles obtained from the computational model using the best-fit diffusivity to the μCT data were consistent with the pseudo color μCT images. Through this approach, the diffusivities of CPA in meniscal specimens were determined at two different temperatures: about 0° C. which is the CPA loading temperature and room temperature of about 22° C. which was used as a control group. The CPA molecules diffused significantly faster at room temperature than at the lower temperatures as shown in FIG. 3E. The CPA concentration profiles of tissues of different thicknesses (e.g., 1, to 3.5 mm) within a total exposure time of 1.5 hours, as well as for 3.5 mm thick tissues with various total exposure times in the range of 1.5 hours to 7 hours, were simulated using the mean CPA diffusivity value at about 0° C. (3.82×10⁻¹⁰ m2/s) as shown in FIGS. 3F and 3G. The simulation curves show that a 1.5-hour CPA loading period resulted in diffusion of over 90% CPA (and even to 95%) in 1 mm thick tissues at about 0° C. However, in the case of 3.5 mm thick tissues, only about 50% of CPAs were able to penetrate the center area within the same loading time. To achieve a greater than 80% CPA concentration of 3.5 mm thick tissues, a longer exposure time of 3 hours or more was required, suggesting that higher concentrations of CPAs improved viability of vitrified tissues.

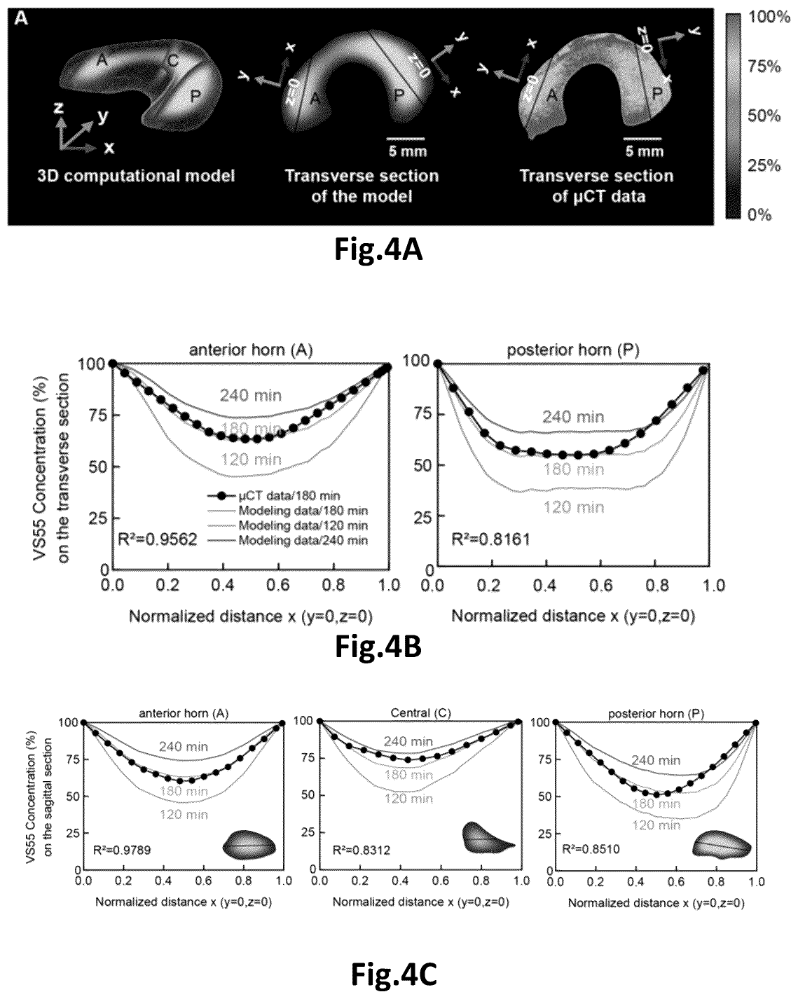

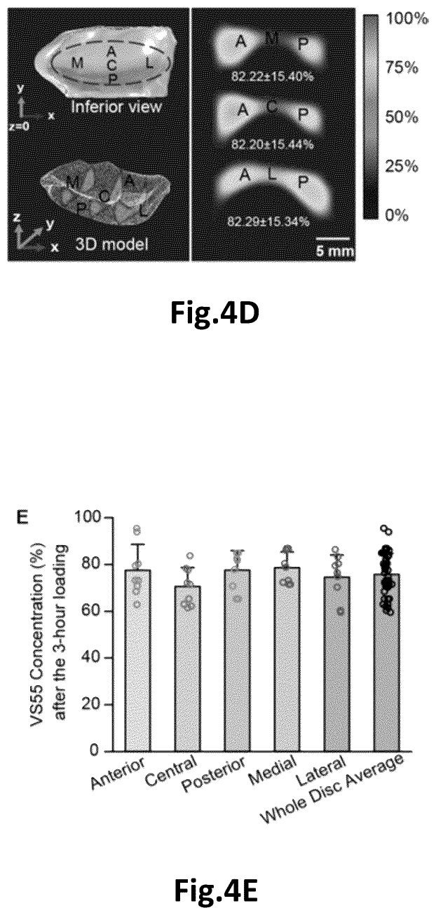

To validate the system, CPA distribution in 3.5 mm thick meniscal specimens after a 1-hour SPA stepwise loading protocol was compared with the model-predicted values. The experimental data aligned well with the modeled curve, as demonstrated by the example shown in FIG. 3H, with an associated R2 value of 0.9061. The system effectively incorporates diffusion principles into the larger-sized geometries of the whole meniscus and TMJ disc. This was achieved through simulation of CPA distribution across the entire structure, as shown in FIGS. 4A through 4E.

In one embodiment, the system can predict CPA concentration in the whole meniscus after a specified loading period, by extracting a transverse section at half thickness and three sagittal sections from distinct regions. Both the modeling and μCT data-derived pseudo color images of the transverse section shown in FIG. 4A exhibited a similar CPA concentration distribution, affirming the agreement between them. Concentration profiles from the horn regions (shown as black lines on the transverse sections in FIG. 4A) further confirmed the strong correspondence between the modeling and experimental data, with an R2 in the range of 0.9 and 1.0 (and in one case 0.9562) for the anterior and in the range of 0.8 to 0.9 (in one case 0.8161) for the posterior region as shown in FIG. 4B. This validation reinforces the accuracy of our CPA diffusion model for the whole meniscus. Additionally, validation of the CPA concentration profiles was also observed in the sagittal sections from different regions as shown in FIG. 4C. It was observed that a loading period of 2 hours did not result in a penetration of CPA beyond about 50%, whereas the lowest CPA concentration across the three regions was found to range of 50% to 75% after about a 3-hour loading. Based on the findings of our study, it was observed that a 3-hour CPA loading period did not have adverse effects on tissue viability prior to vitrification as shown in FIGS. 2A through 2C. Therefore, in subsequent experiments, the 2-hour and 3-hour loading protocols can be employed for vitrification of whole menisci.

In one embodiment, a similar simulation approach was employed for the TMJ discs. The distribution of CPA concentration across the TMJ disc following the 3-hour loading period from both the computational model and the experimental μCT data is illustrated in FIGS. 4D and 4E. Linear calibration curves for TMJ discs equilibrated in different concentrations of CPA solutions are shown in FIG. S2. Given the similar structure between a knee meniscus and TMJ disc, the system can use the same or similar CPA diffusivity value (e.g., 3.82×10⁻¹⁰ m2/s) to predict its concentration distribution within TMJ discs. The system m demonstrates a close alignment with experimental μCT data for the distribution of approximately in the range of 80% to 85% CPA throughout the sagittal sections of anterior-posterior bands in the TMJ disc as shown in FIG. 4D. The experimental μCT data reveals an average concentration ranging from 70.0% to 80.0% across five regions, as shown in FIG. 4E. In one embodiment, no significant difference in CPA concentrations was observed from μCT data across five distinct regions after the 3-hour loading. Further, the system can use loading across 3 hours which can enhance viability in vitrified menisci and TMJ discs.

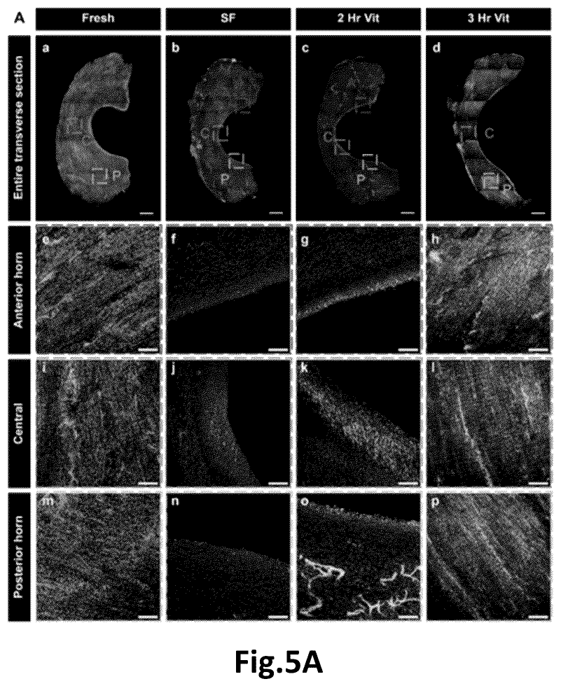

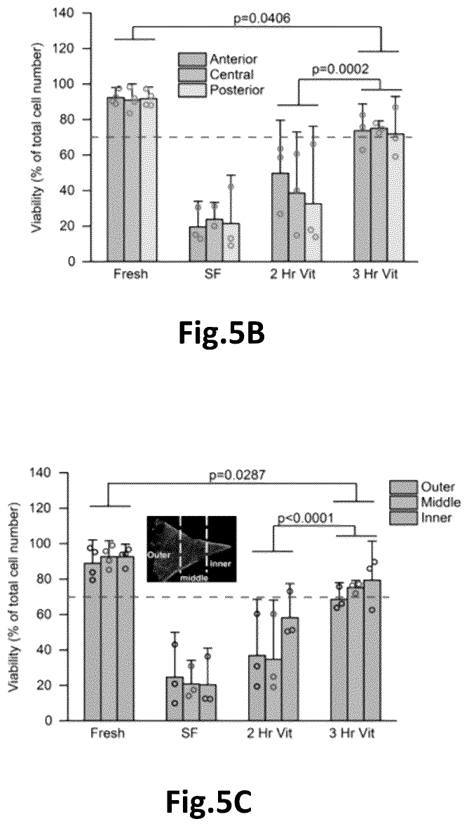

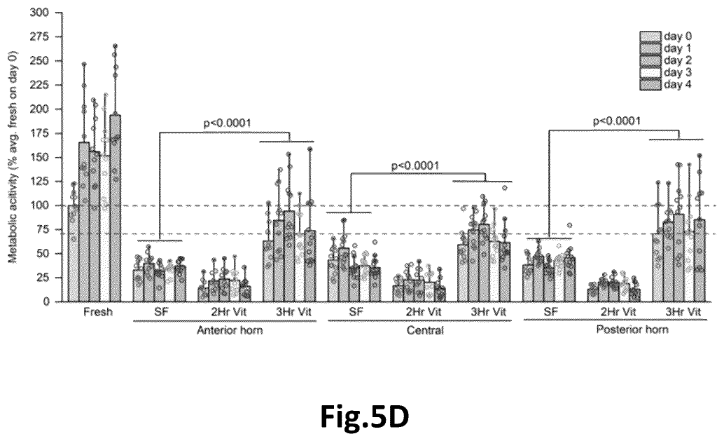

For upscaling to 10-ml whole meniscus vitrification, 2-hour and 3-hour CPA loading protocols can be utilized. Following CPA loading, each meniscus was placed in a 50-ml centrifuge tube containing 10-ml CPA solution and was vitrified by cooling at about 12° C./min until reaching−100° C., followed by a slower cooling to −120° C. at about 4.0° C./min. This results in the formation of a transparent, glass-like state encompassing the sample. For the conventional warming phase, samples were initially warmed slowly to −100° C. at about 18.0° C./min, followed by a faster warming to −35° C. at about 54.0° C./min in an about 37° C. water bath. Viability assessment of vitrified whole menisci was conducted using fluorescence live/dead staining and metabolic activity analysis, with fresh and slow-frozen samples included for comparison. To comprehensively evaluate the distribution of living and dead cells, transverse sections at half thickness of the whole menisci were cut and imaged, enabling observation of all three regions with the lowest CPA concentration as shown in FIG. 5A. As expected, the 3-hour vitrification method exhibited superior maintenance of living cells across all regions compared to slow freezing. The 2-hour vitrified menisci retained only a slim layer of viable cells in the inner region.

Quantitative analysis of viability was conducted in sagittal sections from the three regions shown in FIG. 5B, with each region further divided into three layers: inner, middle, and outer as shown in FIG. 5C. The 3-hour vitrification showed a significantly higher viability in whole menisci, achieving an average of greater than 70%, providing a significant improvement over slow freezing (e.g., ˜21.6%) and 2-hour vitrification (e.g., ˜40.3%) groups. Additionally, region-dependent viability was not observed for each group. When comparing different layers on the sagittal sections there was an increasing trend in viability from the outer layer to the inner layer in the two vitrified groups. This trend can be attributed to the increase in CPA concentration as the thickness decreases from the outer, middle, to the inner layer on the sagittal section.

Metabolic activity of whole menisci from different groups was assessed and compared in different regions, as shown in FIG. 5D. Among all three regions, 3-hour vitrification exhibited significantly better preservation of metabolic activity than slow-freezing and 2-hour vitrification immediately after warming, with the posterior horn showing the most notable improvement, reaching about 70% viability on day 0. In accordance with the metabolic activity pattern observed in fresh tissues, the 3-hour vitrified menisci consistently exhibited an increase, reaching up to and above 70% of metabolic activity in all regions during the 24-hour period. In contrast, the slow-frozen and 2-hour vitrified groups maintained much lower metabolic activity levels over the course of 4 days.

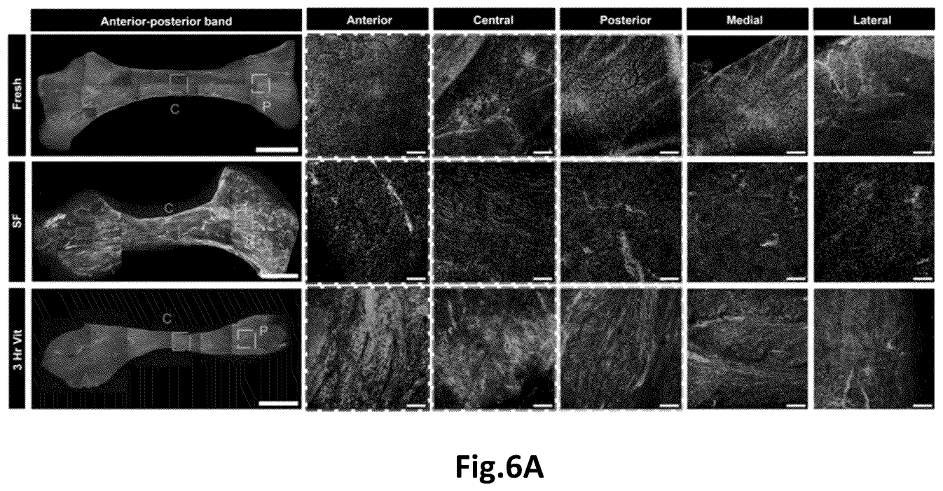

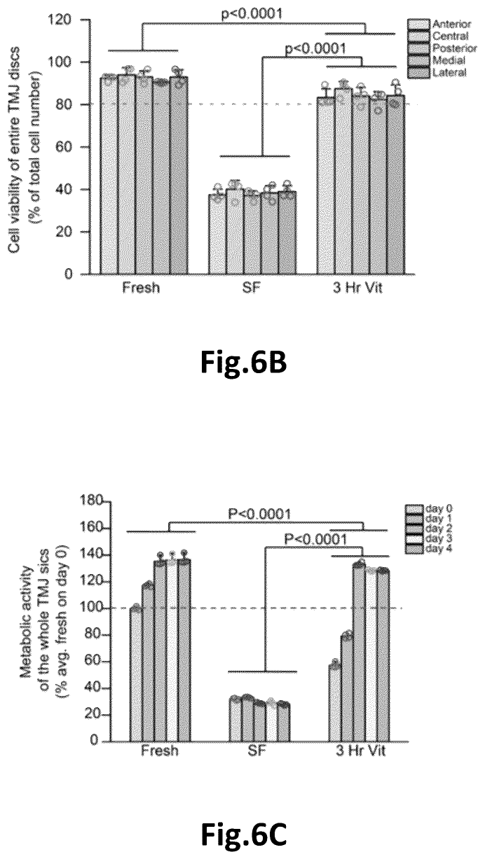

To continuously upscale the volume to 15 ml, whole TMJ discs were gradually loaded with CPA for a duration of 3 hours predicted by this system. The transparent glassy state around the sample was observed by cooling at about 9.0° C./min to a temperature of −100° C., followed by a slower cooling to about −120° C. at about 2.5° C./min. During warming, the samples were first slowly warmed to about −100° C. at about 14.0° C./min, and then warmed faster to about −35° C. at about 30.0° C./min, in an about 37° C. water bath. The vitrification of whole TMJ discs resulted in significantly improved cell viability compared to slow-freezing and comparable to fresh discs, as shown in FIG. 6A using fluorescent live/dead imaging. The system, using quantitative analysis in one embodiment, revealed viability rates across all regions ranging from about 82.0% to 88.0% after vitrification, which is a significant improvement over the slow-frozen samples which exhibited less than 40% viability as shown in FIG. 6B. A similar observation was obtained regarding the metabolic activity of the TMJ discs from day 0 to day 4 post-warming, as shown in FIG. 6C. The vitrified TMJ discs displayed a continuous recovery in metabolic activity over time, fully recovering completely by day 2 post-warming, aligning with the observed increase in metabolic activity seen in fresh tissues. In contrast, this phenomenon was not observed in slow-frozen samples. The system results in ECM and biomechanics of 3-hour vitrified menisci closely resembling fresh samples.

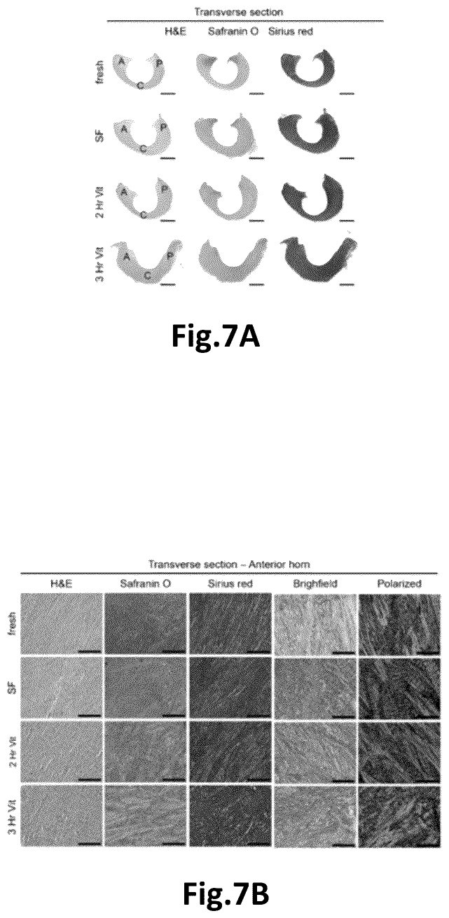

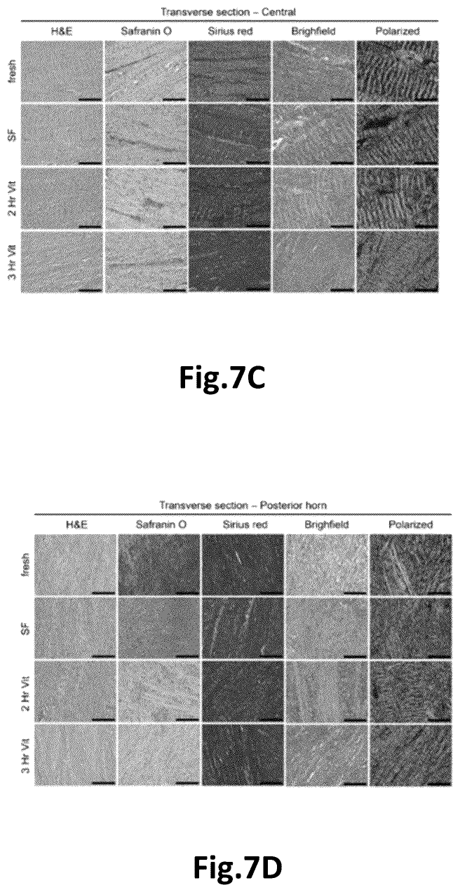

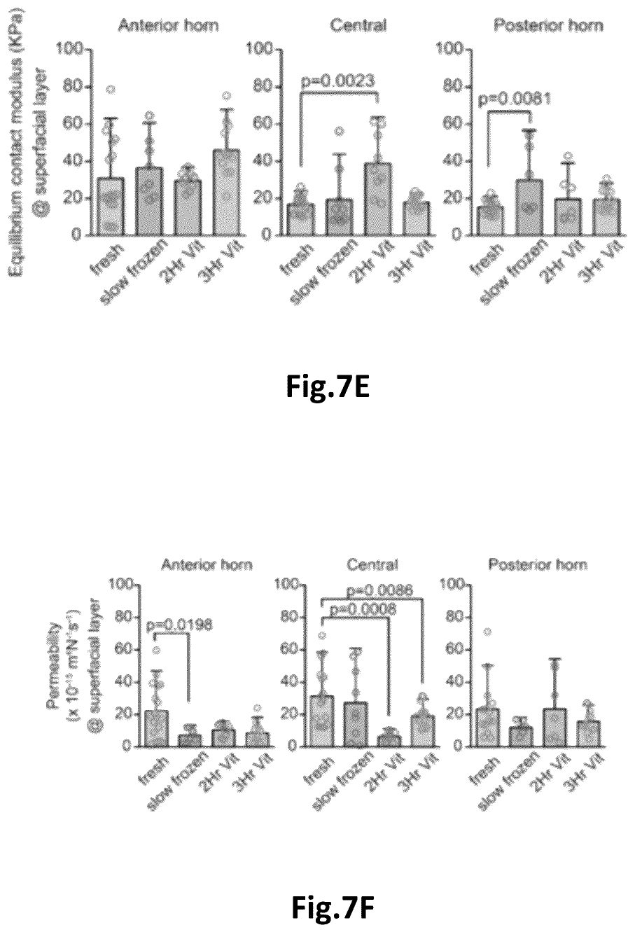

To evaluate the effect of vitrification on the ECM structure and compositions of whole menisci, we conducted histological imaging with hematoxylin & eosin (H&E), Safranin O, and Sirius red stains. The results are depicted in FIGS. 7A through 7D, captured using both brightfield and polarized light microscopes. The use of polarized light microscopy was employed to focus on the examination of collagen fiber structure within the Sirius red-stained samples. In addition, a comparison of the polarized light image with its corresponding brightfield counterpart at the same location was made. To validate the collagen fiber structure observed in polarized light imaging, SEM imaging was used on transverse sections of meniscal samples extracted from the anterior horn regions. For whole menisci, images of the whole transverse sections through all three stains revealed that no significant difference in ECM structure was observed among all four groups. When observing each region in detail, slow-freezing and two vitrification methods effectively maintained ECM compositions in the anterior horn and central regions. Only a slight decrease in glycosaminoglycans (GAGs) in the posterior horn was observed in Safranin O staining images post slow-freezing and vitrification compared to fresh tissues. Polarized light microscopy of Sirius red stained samples did not reveal notable variations in collagen fiber shape and content among the four groups, consistent with SEM observations. Both polarized light images and SEM images of anterior horns of meniscal samples showed only slight differences in collage fiber structure patterns between slow frozen and 2-hour vitrified samples compared to the fresh sample, whereas the 3-hour vitrified meniscal sample exhibit a pattern closely resembling the fresh sample. No apparent differences in ECM structures were observed in sagittal sections across all three regions of the whole menisci, as shown in Figure S3-S5 (Supporting Information).

This system includes an investigation of region-specific mechanical properties of both whole menisci and TMJ discs among various groups including microindentation testing. Equilibrium contact modulus and permeability were assessed to explore the effect of vitrification on tissue biomechanics in both superficial and intermediate layers of whole menisci using this system. The results indicated that the equilibrium contact modulus of the 3-hour vitrified samples remained unchanged across all three regions in both layers after warming as shown in FIG. 7E. Conversely, the slow-frozen samples showed an elevated equilibrium contact modulus in the posterior horn's superficial layer, and 2-hour vitrified samples exhibited an increased equilibrium contact modulus in the central region's superficial layer, in comparison to the fresh samples. Nonetheless, both 2-hour and 3-hour vitrification led to a reduction in permeability within the superficial layer of the central region as shown in FIG. 7F. Interestingly, all three preservation methods exhibited a decrease in permeability within the intermediate layer of the posterior horn. This shows that this system provides for ECM and biomechanics of 3-hour vitrified TMJ discs that closely resemble fresh samples while dramatically improving the current technologies.

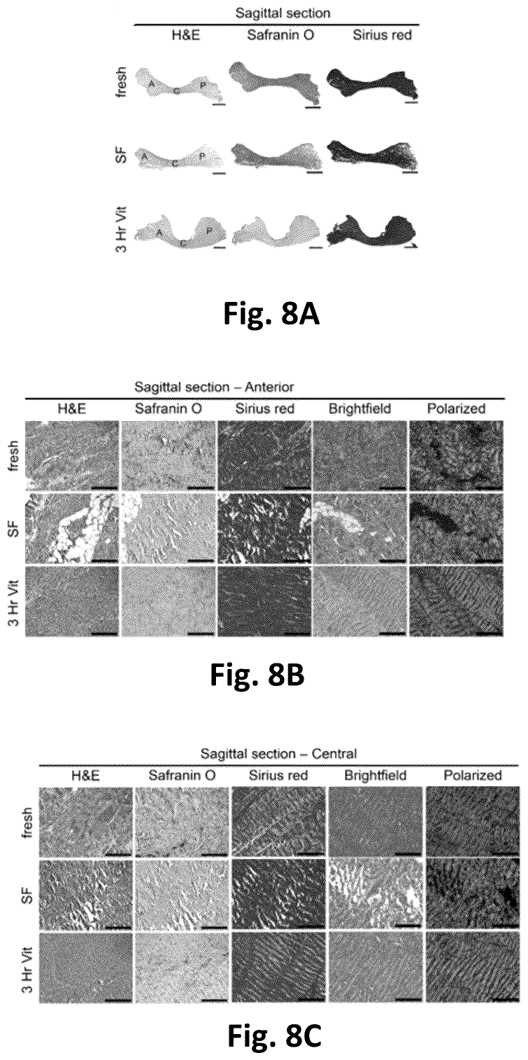

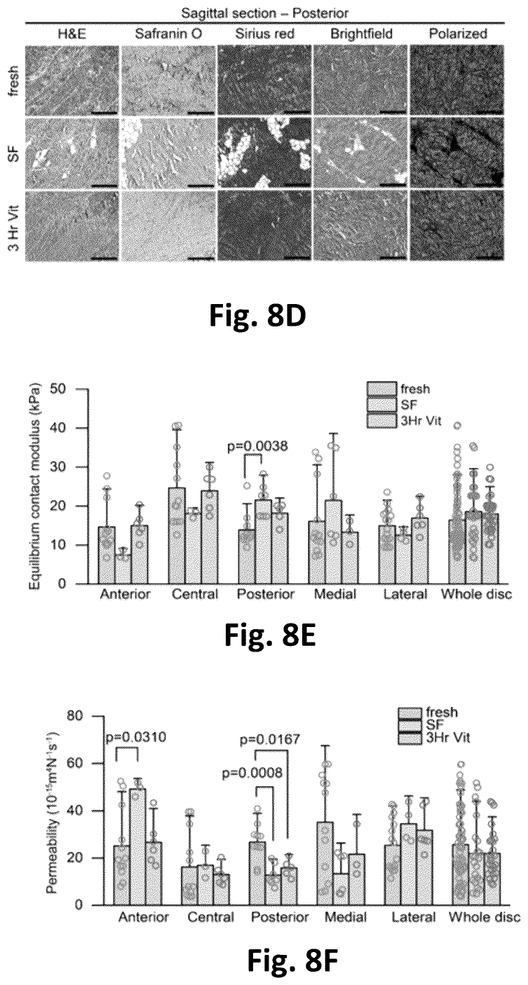

In the evaluation of the ECM structure and composition of TMJ discs, three primary regions, comprising the anterior, central, and posterior, were subjected to histological imaging within three different groups. No significant alteration in ECM structure and composition was observed between fresh and 3-hour vitrified tissues for all three stains, whereas the slow-frozen tissues showed big pores and more severe damage to the collagen network when compared to both fresh and vitrified tissues as shown in FIGS. 8A through 8D. A consistent pattern was observed in both SEM and polarized light images of central regions of TMJ discs under this system. When compared to slow-frozen samples, the 3-hour vitrified TMJ disc samples exhibited collagen fiber structures more closely resembling those of the fresh samples. For mechanical properties, the equilibrium contact modulus and permeability values for the whole TMJ discs did not show significant differences among the three groups (i.e. fresh, slow-frozen, and vitrified).

Furthermore, a more in-depth analysis was conducted by comparing them on a region-specific basis. There were no significant differences in the equilibrium contact modulus across all regions when comparing fresh and 3-hour vitrified samples. However, a decrease in permeability of the posterior region was observed in the 3-hour vitrified compared to fresh samples. In the case of slow-frozen tissues, both equilibrium contact modulus and permeability exhibit significant alterations in posterior regions when compared to fresh tissues as shown in FIGS. 8E through 8F. Notably, in the anterior regions of slow-frozen tissues, a decrease in equilibrium modulus and a significant increase in permeability can be attributed to damage to the collagen network, which is evident from the presence of large pores observed in histological images shown in FIG. 8B, resulting from ice crystal formation.

The vitrification process of this system addresses the shortage of tissues and organs by allowing them to be stored at cryogenic temperatures for extended periods without the damaging effects of ice crystal formation. It has succeeded in maintaining viability of samples with CPA in small volumes (e.g., ≤3 ml) and has potential for larger vascularized tissues and small animal organs using higher CPA concentrations or nanowarming. Prior to this system, applying vitrification to avascular cartilaginous tissues in CPA has been limited to small volumes (e.g., ≤3 ml). This limitation arises from the denser structure, less permeable ECM, increased thickness, and lack of blood vessels in these tissues, making successful vitrification for larger-sized tissues (e.g., >3 ml) exceptionally challenging. Prior to this system incorporation of CPA and nanowarming, improvements are still constrained. Recognizing the urgent and extensive demand for suitable meniscus replacements in the knee joint and TMJ, this system specifically addressed the challenge of vitrifying larger-sized avascular fibrocartilaginous tissues by achieving CPA penetration within a limited timeframe while minimizing CPA-associated cytotoxicity.

To show that efficiency of this system and improvements over traditional methods and systems, small meniscal specimens were used with two different thicknesses: 1 mm and 3.5 mm. Through analysis involving fluorescence live/dead staining images and alamarBlue tests, this system shows that a 1.5-hour CPA loading of 1 mm thick vitrified samples had preserved cells comparable to fresh samples. When the CPA loading time was extended to 3 hours, CPA toxicity is not meaningfully increased, and the vitrified 3.5 mm tissues maintained living cells throughout their full thickness.

The use of this system for simulation-based optimization approach is advantageous to explore the intricate process of CPAs diffusing across tissues of different sizes and shapes, and to improve more rapidly the testing and mechanistic understanding of the vitrification process. μCT imaging-based computational modeling was used to quantify diffusivity by virtue of its rapidity, non-invasiveness, and capacity to capture 3D data. Its efficacy has been demonstrated in previous applications, including the derivation of diffusion coefficients for low Me2SO concentrations within tissue-engineered collagen scaffolds, as well as for high concentrations of vitrification solutions within porcine arteries. μCT imaging is adapted to determine CPA concentrations within meniscal tissues and was synergistically combined with a 3D computational model, which facilitated the derivation of CPA diffusivity through the fitting of μCT-derived data.

This system is a novel approach to provide advantages CPA diffusivity in meniscal tissues, and the diffusivities measured are in good agreement with those measured in other collagenous tissues. The simulation curves of CPA concentration profiles within meniscal specimens yield a compelling rationale for the observed viability outcomes. Notably, the predictions elucidate the relationship between CPA diffusion and viability. For the 1 mm thick tissues, a 1.5-hour CPA loading period led to about a >90% center loading, resulting in comparable viability to fresh tissues. However, for 3.5 mm thick tissues, the simulation predicted 50% CPA diffusion in center areas after 1.5-hour loading, leading to reduced viability (e.g., 23%). Extending the loading to 3 hours yielded 85% viability due to >80% CPA center loading. This achievement highlights the crucial role of time in ensuring sufficient CPA diffusion for successful vitrification.

CPA diffusivity was subsequently employed to predict concentration profiles for varying exposure times throughout the whole menisci and TMJ discs, scaled up to total volumes of 10 ml and 15 ml, regardless of their specific geometries. This predictive capacity provides invaluable insight into the optimization of CPA loading times for larger-sized tissue vitrification. Following the simulation of CPA distribution throughout the whole 3D tissue geometry models, this system fitting analysis on three primary regions of each meniscus—the anterior horn, the central region, and the posterior horn—in both transverse and sagittal sections, while five regions of TMJ discs, comprising anterior, posterior, medial, lateral, and central, was analyzed.

The 3D simulation of the present system revealed a location-dependent CPA concentration. The μCT validation reinforces the accuracy of our CPA diffusion models for both meniscus and TMJ disc. Notably, the lowest CPA concentration in each region was in the rage of 50% to 75% CPA through the whole meniscus following 3-hour loading, in contrast to less than 50% CPA diffused within the tissue after 2 hours. For CPA distribution throughout the whole TMJ disc, both the computational model and experimental μCT data confirmed more than 75% CPA penetration after the 3-hour loading period. As a result, the 3-hour CPA loading protocol was used for the vitrification of whole TMJ discs in one embodiment.

The efficacy of the optimized 3-hour CPA loading period was then assessed on whole knee menisci and TMJ discs, examining both cellular and tissue level impacts. The 3-hour vitrified knee menisci yielded significant improvements in both cell membrane integrity and metabolic function. These improvements led to a viability rate of approximately 70%. In contrast, the 2-hour vitrified menisci displayed a depth-dependent viability pattern. Only a thin layer of living cells was preserved on the surface of the inner layer, resembling our prior observations involving larger-sized articular cartilage. Upon examining the ECM structure of the whole knee menisci, no significant alterations were detected in the overall tissue structure and collagen networks within the 3-hour vitrified groups as compared to the fresh tissues. Nevertheless, a decrease in GAG content was observed in 3-hour vitrified menisci when compared to fresh tissues. This reduction could be attributed to leaching resulting from prolonged exposure to CPA solutions. While this decline in GAG content correlated with a statistically significant decrease in permeability observed during biomechanical tests, it did not exert a substantial impact on the biomechanical strength (equilibrium contact modulus) of the tissue. The TMJ discs, vitrified with this new approach, had nearly 85% viability and a full recovery of metabolic activity after day 2 post warming, even when scaling the volume up to 15 ml. Moreover, the collagen network of vitrified TMJ discs closely resembled that of fresh tissues. In contrast, the ECM structure of slow-frozen samples exhibited severe damage such as pores and cracks. No significant changes in biomechanical strength (equilibrium contact modulus) of vitreous TMJ discs across all regions were observed when compared to fresh tissues.

Notably, the 3-hour duration of CPA loading did not give rise to CPA-associated toxicity concerns for knee menisci and TMJ discs. Conventional convective warming proved a successful combination with this CPA loading for 3 hours, which can be primarily attributed to the addition of sucrose and trehalose. Our differential scanning calorimetry (DSC) analysis revealed that these additives significantly improved the glass forming ability of CPA, raising its glass transition temperature from about −121.0° C. to about −116° C. As a such, the critical cooling rates (CCR) decreased from about 2.5° C./min to below about 2° C./min and the critical warming rates (CWR) CCR dropped from about 50° C./min to below about 10° C./min. The addition of these sugars ensured that our systems met their CCRs and CWRs, provided that the tissues could be fully penetrated by the CPA solutions. As CCR and CWR decreased, the slow cooling and warming procedures used in our systems could help mitigate thermal stress, especially within larger-sized volume of the system. According to our findings, there was no evidence of thermal stress-induced damage during vitrification and warming, such as cracking or structure fractures.

To consider scaling up to larger fibrocartilaginous avascular tissues such as human intervertebral discs, an extended CPA loading period can be optimized using the simulation approach. In the case where the CPA loading period surpasses the maximum acceptable exposure time (due to CPA-induced cytotoxicity) before achieving the required CPA penetration, our simulation approach can provide invaluable insights into CPA concentration and distribution throughout the tissues. To prevent the formation of ice crystals during the warming process, faster warming methods such as nanowarming or removing surrounding vitrification solution could be considered in conjunction with the optimized CPA penetration. As a result, due to the heightened thermal gradient resulting from faster warming methods, it will be advantageous to exercise precise control over thermal stress within upscaling systems.

While this system testing predominantly focused on vitrification of fibrocartilaginous avascular tissues, the applicability of this system extends to diverse musculoskeletal tissues. This system provides a deeper understanding of how CPAs permeate each distinct tissue type, such as articular cartilage, bone, and the cartilage-bone interface, our approach holds the potential to enhance future optimization of CPA loading procedures for large-sized OCAs. The simulation approach developed in this system was validated against experimental data obtained from μCT, indicating a reasonable alignment between the simulation results and the empirical data. This alignment serves as an indicator of the accuracy and reliability of the simulation under the assumption of homogeneous and isotropic diffusion. In some testing, non-human tissue was used. However, human menisci are expected to present fewer challenges in terms of CPA penetration and hold greater potential for successful vitrification.

The present system makes four significant contributions towards the addressing the shortage of suitable knee meniscus and TMJ disc replacements. First, it pinpoints a critical obstacle impeding the application of vitrification to larger-sized avascular fibrocartilaginous tissues, which revolves around achieving adequate CPA penetration. Second, is effectively tackles this challenge by developing a μCT imaging-based computational modeling approach to optimize the CPA loading period, thereby ensuring adequate CPA penetration. Third, it facilitates the upscaling of vitrified tissue volumes to about 15 ml, while leading to substantial improvements in viability (e.g., ≥70%) that hold great promise for future clinical applications. Fourth, by focusing on the whole knee meniscus and TMJ disc, this research lays the groundwork for future development of long-term preservation methods of viable human meniscus and TMJ disc grafts. It introduces a valuable repository of high-quality vitreous tissue, serving both transplantation needs and diverse research pursuits. Notably, this pioneering work represents the first successful application of vitrification strategies to preserve whole viable grafts in both tissue types which opens new avenues for the successful preservation of various avascular tissues and holds the promise of facilitating widespread adoption of viable graft transplantation and research endeavors.

This system is designed to overcome some of the problems with inadequate CPA penetration, vitrification for avascular musculoskeletal fibrocartilaginous tissues challenges optimizing CPA loading periods. This system is shown to have overcome these issues in the past technologies in one test that uses a 4-ml small meniscal specimen. The testing results demonstrated that viability of vitrified samples depended on diffused CPA concentrations which can be shown with a 3D computational model in the system using finite element analysis and determining best-fit CPA diffusivity values from experimental μCT scans. This system predicts CPA distribution throughout the meniscus and TMJ disc, considering various geometries and loading periods. Using these prediction functions, the viability of vitreous samples through fluorescent live-dead imaging and alamarBlue assays, comparing findings with fresh and slow-frozen samples resulting in this system improving the existing technologies. Histological analysis and microindentation assessed ECM structure, compositions, and mechanical properties. Testing was replicated multiple times (e.g., N≥3), with blinded tissue analysis. Pre-established criteria were used for exclusions, considering contamination, inflammation, and defects. Outliers from time-course metabolic activity assessments were excluded starting from the day when sample contamination occurs (e.g., the RFU values were typically ten times higher than those of fresh samples). Menisci and TMJ discs underwent randomization from a pool of N testing animals. Each individual meniscus or TMJ disc within every experimental group originated from distinct animals, where n represents the count of specimens or measurements, accounting for cases where multiple specimens or measurements were taken from an individual meniscus or TMJ disc.

For investigations involving 4-ml small meniscal specimens and 15-ml whole TMJ discs, menisci and TMJ discs were procured from male and female animals, Yorkshire pigs that were 8-9 months old and approximately 150 kg in one case, and within 6 hours of demise and acquired from a local slaughterhouse. For the 4-ml system, cylindrical meniscal specimens (e.g., 5 mm diameter) of two thicknesses (e.g., 1 mm or 3.5 mm) were prepared in the superior-inferior direction in the center region of each meniscus using a micro dissecting trephine and a custom cutting tool with parallel razor blades. For the 10-ml whole menisci studies, intact medial and lateral menisci were procured from male domestic Yorkshire pigs 4-6 weeks and around 10 kg. Leg removal occurred within 30 minutes of the animal's demise following approved research protocols. All tissues were surplus sources, eliminating the need for specific euthanization for this research. In one testing case, tissues were immediately placed in Dulbecco's Modification of Eagle's Medium (DMEM) with 1 g/L glucose, L-glutamine, and sodium pyruvate supplemented with 100 IU/ml penicillin and 100 μg/ml streptomycin (DMEM/P/S) at 4° C. and randomized for subsequent experiments.

In one case the CPA is VS55 composed of dimethyl sulfoxide, Me2SO, 3.1M), formamide (3.1M) and propylene glycol (PG, 2.4M) was employed for all CPA loading procedures. The VS55 was supplemented with sucrose (0.3 M) and trehalose (0.3 M) (referred to as VS55/S/T) was used for tissue vitrification. Sucrose and trehalose were added to facilitate glass formation and prevent ice crystal formation during cooling and warming. All samples were gradually infiltrated with VS55 (8.4M) in 1×Euro Collins (EC) solution at about 0° C. The precooled diluted vitrification solutions were added in six sequential 15-min (total 1.5 hours), 20-min (total 2 hours) or 30-min (total 3 hours) steps at increasing concentrations (0%, 18.5%, 25%, 50%, 75%, and 100%) on ice in one embodiment. Each sample was then transferred to a 20-ml glass scintillation vial containing 4 ml VS55/S/T (for small meniscal specimen), or a 50-ml centrifuge tube containing 10-ml (for whole meniscus) or 15-ml (for whole TMJ disc) VS55/S/T. For the 4-ml system, the top of the vitrification solution was then covered with 1 ml of 2-methylbutane (Sigma-Aldrich, MO) to prevent direct air contact. Subsequently, samples were successfully vitrified and stored in at about −135° C. mechanical storage freezer over 48 hours.

For conventional cryopreservation by slow freezing, samples were exposed to Me2SO (10% v/v) in DMEM with 1% P/S for 30 min at 4° C. and then transferred respectively to the same corresponding containers with the same corresponding CPA volumes of Me2SO (10% v/v) with those used for vitrification. Conventional cryopreservation was performed by cooling slowly to −80° C. at −1° C./min using a control-rate freezer. In one case the cryo freezer was a Kryo 560. The slow-frozen samples were then stored at about −160° C. in vapor phase nitrogen for a minimum of 48 hours.

Warming of all vitrified and slow-frozen tissue samples was accomplished by convectively warming in a about 37° C. water bath, whereupon the vitrification solution was removed in several sequential steps at 0° C. into DMEM/P/S culture medium as previously described and 10% Me2SO was removed in DMEM/P/S twice at 4° C. for about 30 min in total. Fresh and preserved samples underwent viability assessment using fluorescence live/dead staining and metabolic activity using an alamarBlue assay (BIORAD, California). Comprehensive protocols for viability and metabolic activity assessment are available in Supporting Information.

CPA diffusivity in meniscal tissues can be determined by using a μCT-based simulation approach. μCT can be used to determine CPA concentration in meniscal tissues after the 90-min stepwise CPA (e.g., VS55) loading. A thin transverse section at half thickness of each sample was scanned using a micro=CT scanning device ans shown in FIG. 3A. The greyscale values (u) of the pixels on the diameters of the μCT-scanned transverse sections were extracted using a Radial Profile Plot plugin in ImageJ software (NIH) and converted to HU values. Referring to the correlations between HU and CPA concentration found in this study, the corresponding CPA concentration values were determined. Simulation software was used to build a 3D model for the diffusion of CPAs into the meniscal specimen (e.g., s specimen with a diameter of 5 mm and its measured thickness). A time-dependent CPA concentration boundary condition was used to simulate the several CPA loading steps, six in one embodiment. In one embodiment, the diffusion was homogeneous and isotropic, and the diffusivity was quantified by fitting the modeling curves to the experimental data of samples through a least squares method. To simulate the effect of exposure time on CPA concentration, increasing or decreasing total exposure time was achieved by equally increasing or decreasing the time at each step. For example, adding 5 min per step increases the total exposure time by 30 min in one embodiment. A validation of the computational model can be conducted through a comparison between the modeling curves and the experimental data of samples loaded with CPA at about 0° C. over a total exposure time that can be 60 min that includes 10 min steps.

In one embodiment, the 3D geometry models of meniscus and TMJ disc were captured using a Micro-Ct scanner, reconstructed, and then created with a second-order tetrahedral mesh for CPA concentration simulation in the COMSOL Multiphysics software. The concentration profiles of the meniscus after different CPA loading periods can be simulated using the 3D model and compared to those from μCT data for about 3 hours, using the VS55 diffusivity determined at about 0° C. This analysis can include both transverse and sagittal sections. The ensuing evaluation can involve the calculation of the R-square value. Leveraging the analogous structure shared between knee meniscus and TMJ disc, the mean value of VS55 diffusivity at 0° C. derived from meniscal tissues can be determined to predict CPA concentrations across the whole 3D TMJ disc model after the loading period (e.g., 3 hours) and compared it with the experimental ρCT data.

In one testing, the system included the collection of whole menisci from the four groups (e.g., fresh, slow-frozen, 2-hour vitrified, and 3-hour vitrified) and TMJ discs collected from the three groups (e.g., fresh, slow-frozen, and 3-hour vitrified) underwent fixation in a 10% formalin solution for a duration of 48 hours. Subsequently, these samples were dehydrated and embedded in paraffin. Microtome transverse or sagittal sections 5 μm in thickness were prepared and stained with Hematoxylin & Eosin (H&E), Safranin O, and Sirius red. Bright-field images were captured using ×2 and ×20 objectives on a microscope. The polarized light images, along with their corresponding brightfield counterparts, were captured using×20 objective on a microscope.

In one testing, whole menisci were collected from the four groups: fresh, slow-frozen, 2-hour vitrified, and 3-hour vitrified. Whole TMJ discs were collected from the three groups: fresh, slow-frozen, and 3-hour vitrified. Preserved samples were incubated for one hour at 37° C. following warming and CPA removal steps prior to microindentation testing. Each meniscus was separated into three sections consisting of the anterior horn, central region, and posterior horn. Each section was initially tested along the superficial layer of the meniscus. Samples were then shaved and tested along the intermediate layer of the meniscus. Only the superficial layer of each whole TMJ disc was tested. Thickness measurements were taken using a current sensing micrometer with the values averaged to determine the meniscus section thickness. Sample attachment to the sample holder used a small amount of cyanoacrylate. PBS solution was used to immerse the sample, and the holder was aligned to ensure that the indention tip was perpendicular to the surface tested. The microindentation testing protocols and data analysis methods are available in Supporting Information.

The data from the system was analyzed using statistical analyses software and included the Figures. In one embodiment, differences were considered significant when p<0.05.

### EXAMPLES

In the examples provided herein, the specific values (e.g., when a range of not provided) can be the values or can be representative of a range of values with the ranges being generally 5% tp 100% above and below the provided values.

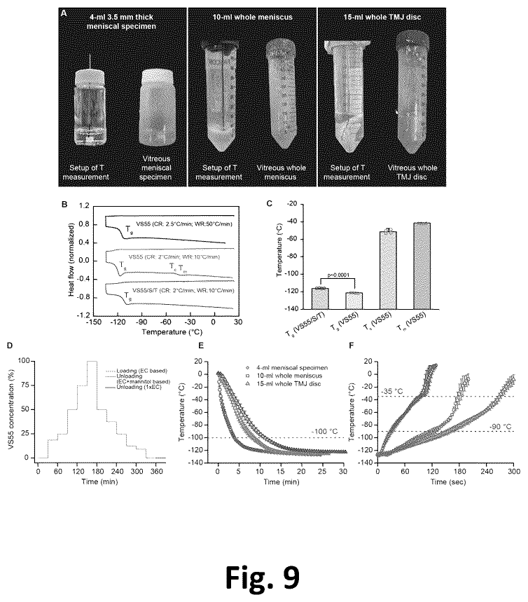

To assess the cooling and warming rates of our vitrification system, a fiber optic temperature sensor was positioned on the top surface of a 3.5 mm thick meniscal specimen in a 20-ml glass vial, a whole meniscus within a 50-ml centrifuge tube, or a whole TMJ disc within a 50-ml centrifuge tube. Each vial or tube contains either 4-ml, 10-ml, or 15-ml CPA (VS55 in some embodiment) supplemented with sucrose (0.3 M) and trehalose (0.3 M) solutions for the 3.5 mm thick meniscal specimen, the whole meniscus, or the whole TMJ disc respectively, as illustrated in FIG. 9. During cooling and convective warming, the temperature profiles were monitored at 1-second intervals using a fiber optic thermometer. The cooling rates were determined by dividing the reduction in temperature by the corresponding time interval for both the range of 4° C. to −100° C. and the range of −100° C. to −120° C. Similarly, warming rates were determined by dividing the increase in temperature by the corresponding time interval within one range of −125° C. to −35° C. for the 4-ml meniscal specimens, and two ranges including −125° C. to −90° C., and −90° C. to −35° C. for 10-ml meniscus and 15-ml TMJ disc, respectively.

A differential scanning calorimeter can be used to monitor thermal events, including the formation of ice crystals and the glass transition of CPA (e.g., VS55 and VS55/S/T) during both cooling and warming processes. Each CPA sample with a volume of 10 ml was loaded into an aluminum pan, with an empty aluminum pan serving as a reference. To ensure the accuracy of our DSC procedures, we initially conducted DSC scans for CPA at its critical cooling rate (e.g., CCR, 2.5° C./min) and critical warming rate (e.g., CWR, 50° C./min). Subsequently, we proceeded with DSC scanning protocols for both VS55/S/T and VS55, on one embodiment, which involved a cooling rate of 2° C./min down to −135° C., followed by a warming rate of 10° C./min to reach 25° C. The analysis was performed using software associated with one or more equipment manufacturers. Glass transition temperatures (T_{g}) were determined as the midpoint of the temperature range over which the change in specific heat, corresponding to the transition from glassy to liquid state, occurred. In the case of ice recrystallization, we determined the peak temperatures of ice recrystallization (T_{c}) and melting (Tₘ). For reference, the lowest cooling and warming rates identified for our various tissues were 2.4±0.4° C./min and 13.9±1.1° C./min, respectively, for 15-ml whole TMJ discs, as detailed in Table 1.

Tissue viability was assessed by fluorescence live/dead staining. Each cylindrical specimen was longitudinally divided into two sections for imaging along the sagittal plane. To comprehensively assess the whole meniscus, both transverse and sagittal sections were prepared. In the case of transverse sections, a 300 μm thick slice of the whole meniscus was obtained using a vibrating blade microtome due to its larger surface area. For sagittal sections, approximately 1-2 mm thick slices were manually cut from corresponding regions. For the TMJ disc samples, strips measuring 6 mm in width, encompassing the anterior, central, posterior, medial, and lateral regions, were manually excised from the whole disc using a scalpel. All cut meniscal slices were immersed in DMEM with 1% P/S culture medium with 4 μM calcein AM and 2 μM ethidium homodimer-1 at room temperature for 2 hours before imaging. In contrast, the TMJ slices underwent staining with distinct dye concentrations: 2 M calcein AM and 4 μM ethidium homodimer-1, following the same set of conditions. The green-fluorescent calcein indicates living cells by intracellular esterase activity, while the red-fluorescent ethidium homodimer-1 indicates dead cells by loss of plasma membrane integrity. All images were captured using an inverted multiphoton laser scanning microscope. The excitation wavelength was set as 800 nm. Green fluorescence was collected within the 495-540 nm range, and red fluorescence was collected in the 575-630 nm range. Images were taken at a depth of 60 μm below the tissue surface. The whole transverse section images of the whole menisci and the whole sagittal section images of the TMJ disc strips were captured using a 4× objective magnification and stitched together. An interesting view of each region was imaged using a higher objective magnification of 10×. All sagittal section images for meniscal specimens, three primary regions of whole menisci, and five primary regions of whole TMJ discs were captured using a 10× objective magnification for quantitative analysis. Live/dead quantification of 3.5 mm thick specimens was performed within the middle layer image (with a thickness of 1.26 mm) to avoid the count of dead cells on both surfaces associated with manual sectioning. In the context of sagittal sections in each region of the whole meniscus, images were acquired, and cell viability was quantified for the inner, middle, and outer layers. Images of sagittal sections in each region of the TMJ disc were acquired and used for viability quantification. Live/dead quantification was performed using software. Cell viability was defined as the proportion between the count of viable cells and the total cell count (comprising both live and dead cells).

Following the completion of the warming and unloading steps, all tissues were subjected to recovery in DMEM supplemented with 1% P/S (e.g., DMEM/P/S) for one hour within a 37° C. incubator. Subsequently, the alamarBlue assay was conducted to assess the metabolic activity of tissues. This assay employs a water soluble fluorometric viability indicator, relying on the detection of metabolic activity. Specifically, it utilizes an oxidation-reduction (REDOX) indicator that exhibits both fluorescence and color changes in response to the chemical reduction of the growth medium due to cell metabolism. In the case of each meniscal specimen and each TMJ disc, evaluations were carried out both before and after different preservation treatments. For the whole meniscus, each fresh, slow-frozen, or vitrified sample underwent manual sectioning into sagittal sections, each measuring 1-2 mm in thickness, spanning from anterior to posterior horn. Within each region, a minimum of three sections were obtained.

Either each individual specimen or each section of the whole meniscus was incubated in 1 ml of DMEM/P/S and 100 μl alamarBlue reagent. This process was carried out under standard cell culture conditions for 3 hours. In contrast, each whole TMJ disc was incubated in 5.4 ml of DMEM/P/S and 600 μl alamarBlue reagent under standard cell culture conditions for 4 hours. Subsequently, fluorescence measurements were conducted in duplicate using a multimode microplate reader at an excitation wavelength of 544 nm and an emission wavelength of 590 nm. Following assessment, each sample was rinsed with DMEM/P/S for 30 mins to remove the alamarBlue reagent prior to proceeding with subsequent measurements. The time-course viability from day 0 to day 4 for each sample was assessed. In the case of meniscal specimens and whole TMJ discs, the results (expressed in relative fluorescence unit, RFU) of the slow-frozen and vitrified groups were normalized to the measurements taken from their respective fresh samples before any preservation treatments were applied. For the measurements of the whole meniscus, the results (expressed as RUF/mg of dry weight) from the slow-frozen and vitrified menisci were normalized to the corresponding values of fresh menisci within the same batch. Dry weight values of samples were measured using an analytical balance after being placed in a 60° C. oven over 48 hours subsequent to the completion of the time-course alamarBlue assay.

To validate the collagen fiber structure observed in polarized light imaging, we conducted SEM imaging on meniscal samples extracted from the anterior horn regions and TMJ disc samples from central regions, following previously established procedures [2]. The samples were meticulously sectioned and subsequently fixed with a 2.5% glutaraldehyde solution in PBS at 4° C. for 72 h. The fixed tissues underwent a dehydration process using a graded series of ethanol. Afterward, the specimens were dried by immersion in hexamethyldisilazane (HMDS) solution. To enhance the contrast of SEM images, the specimens were coated with a layer (20 nm thickness) of gold. Finally, the coated specimens were examined via SEM at 1500× magnification.

Meniscal specimens from the 3.5 mm group were trimmed on both sides using a microtome to ensure a flat surface. The thickness of each specimen was measured as an average value of three measurement points using a custom current-sensing micrometer with a precision of 0.001 mm and was used as a geometry input to the computational model. μCT imaging was used to determine the CPA concentration in meniscal tissues and TMJ discs. To obtain CPA concentration profiles of meniscal tissues, a thin transverse section at half thickness of each sample was scanned (See FIG. 3A). The accelerating voltage was 55 kV and the applied current was 72 μA. The resolution was 30 μm. An image matrix of 1024×1024 pixels was used to reconstruct a field of view (FOV) with a diameter of 30.7 mm. Each scan took 15 min. For the TMJ disc, the transverse section across the full thickness of each disc was scanned. The accelerating voltage was 70 kV and the applied current was 114 μA. The resolution was 18 μm. An image matrix of 2048×2048 pixels was used to reconstruct a FOV with a diameter of 36.9 mm. Each scan took 50 min. The X-ray attenuation values were expressed in Hounsfield units (HU). In the Hounsfield scale, water is defined as a value of 0 HU. All other CT values are computed according to

$$HU = 1000 \times \frac{{μ}_{tissue} - {μ}_{water}}{{μ}_{water}} \qquad ( 1 )$$

in which μ is the CT linear attenuation coefficient.

Diluted CPA solutions were used to generate tissue calibration curves. Meniscal specimens and whole TMJ discs were loaded with various concentrations of CPA solutions (e.g., 0, 25%, 50%, 75%, and 100% VS55) for 7 days to reach diffusion equilibrium. The tissues were then imaged to generate the tissue calibration curves. The average HU value within a 1 mm diameter area located at the central region of meniscal samples, and in five distinct regions of TMJ discs, was used to assess correlations with CPA concentrations.

To capture the 3D geometry models of the whole meniscus and TMJ disc, each sample was enveloped in plastic wrap and then scanned at room temperature. The meniscus was scanned before CPA loading, after a 3-hour CPA loading, and after 7-day saturation for both 3D geometry capturing and CPA concentration validation, whereas the TMJ disc was only scanned after 7-day saturation to capture the 3D geometry. Images were captured, employing the following parameters: a resolution of 18 μm/pixel, X-ray settings of 50 kV and 500 μA, aided by a 0.5 mm aluminum filter, and a full rotation scan spanning 360° C. The resulting imagery was reconstructed into an image matrix of 3884×3884 pixels. For meniscus and TMJ disc modeling, we initially performed image segmentation to extract the 3D surface geometry of the meniscus from the μCT images, and then converted from the segmented surface geometry to solid geometry using 3D modeling software, facilitating the creation of a solid mesh. With meshing modeling software, we proceeded to generate a second-order tetrahedral mesh, characterized by an average size of 0.5 mm. The mesh was then exported to a finite element analysis systems.

Microindentation tests were performed using a bioindenter system. The resolution for the force and displacement were down to 0.001 μN and 0.006 nm, respectively. A spherical ruby ball indenter (1 mm diameter) was used for the creep test. A 5 μN tare load was applied for 300 s, followed by a 125 μN step load for 800 s to generate the creep data. The indentation force and displacement data were acquired at 20 Hz. Two to three indentation tests were spaced about 500 μm apart. The creep data were analyzed with Hertzian biphasic theory to obtain the equilibrium contact modulus and the hydraulic permeability of the disc ^{[3]}. To confirm our microindentation protocol, we employed trypsin-EDTA solutions (0.25%) to treat TMJ discs for 2 hours at room temperature, with the intention of damaging the ECM structure, thereby creating a negative control group.

Referring to FIG. 9, CPA loading, vitrification and convective warming of different tissue volumes is shown. (A) Photographs of vitreous tissues including a 3.5 mm thick meniscal specimen, a whole meniscus, and a whole TMJ disc showing transparent amorphous states in VS55 supplemented with 0.3M sucrose and 0.3M trehalose (VS55/S/T) surrounding tissues, along with setups for temperature measurements. (B) DSC thermal curves of VS55 and VS55/S/T solutions at different cooling and warming rates. T_{g}: glass transition temperature; T_{c}: recrystallization temperature; Tₘ: melting temperature. (C) Phase transition temperatures for VS55/S/T (N=4) and VS55 solutions (N=4) determined by DSC scanning. p-value determined with a two-sided t-test. Data presented as the mean±SD. (D) Loading and removal steps of VS55 for optimized 3-hour loading protocol. (E) Cooling and warming profiles of porcine meniscal specimens (blue, N=3), whole menisci (green, N=3), and whole TMJ discs (red, N=3) during vitrification and convective warming. N=number of independent menisci.

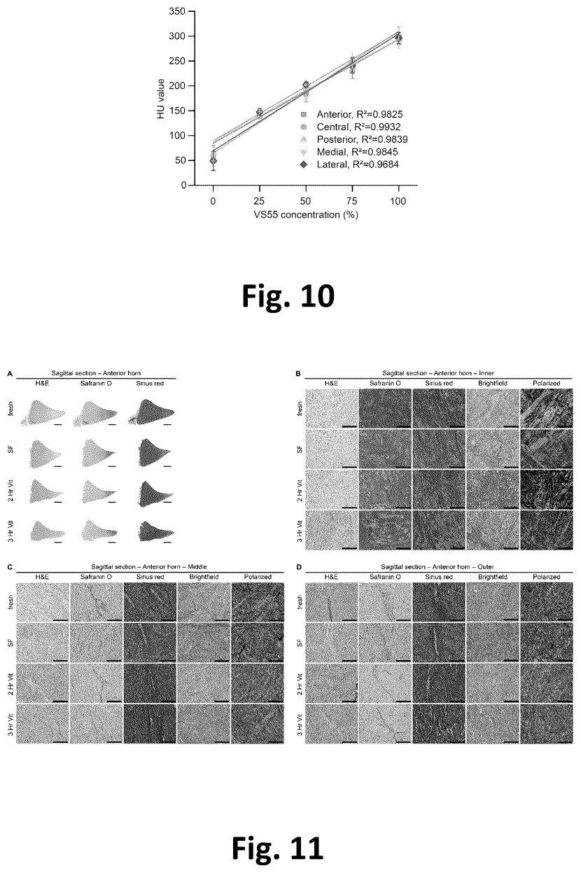

Referring to FIG. 10 μCT calibration curves of TMJ disc is shown. HU values obtained by μCT for five distinct regions of TMJ discs equilibrated in different concentrations of VS55 solutions (N=3). N=number of independent TMJ discs.

Referring to FIG. 11, representative histological images of whole menisci in sagittal sections of the anterior horn are shown. (A) Representative images stained with H&E, Safranin O, and Sirius red, exhibiting the whole sagittal sections of the anterior horn across various groups: fresh, slow-frozen (SF), 2-hour vitrified (2 Hr Vit), and 3-hour vitrified (3 Hr Vit). Magnifications: 2×. Scale bars represent 2 mm. Their corresponding expanded view of the inner (B), middle (C), and outer (D) layers was captured at a 20× magnification, with scale bars set at 200 μm. The polarized light images, along with their corresponding brightfield counterparts, were captured at 20× with 200 μm scale bars.

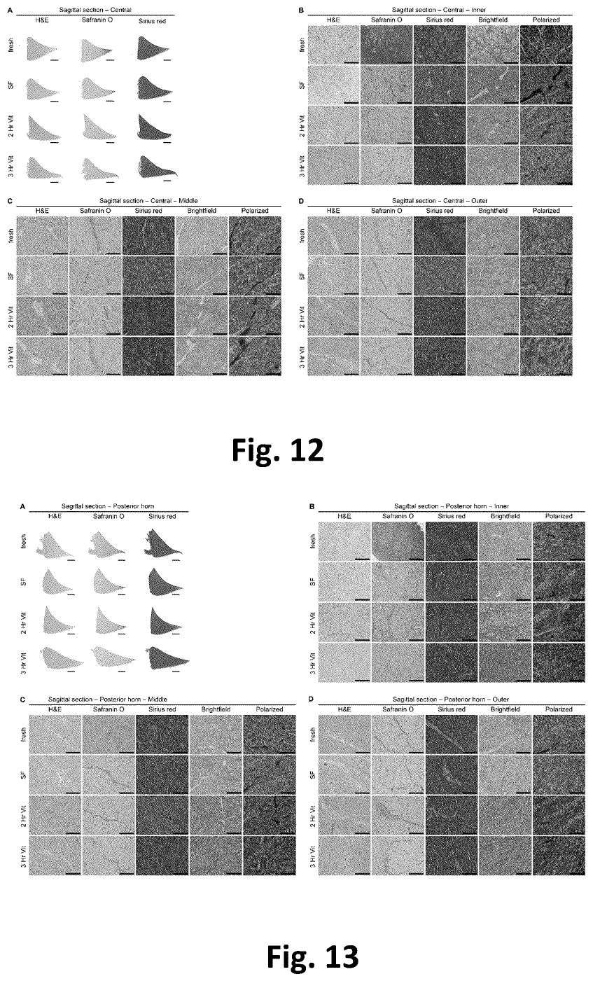

FIG. 12 shows representative histological images of whole menisci in sagittal sections of the central region. (A) Representative images stained with H&E, Safranin O, and Sirius red, exhibiting the whole sagittal sections of the central region across various groups: fresh, slow-frozen (SF), 2-hour vitrified (2 Hr Vit), and 3-hour vitrified (3 Hr Vit). Magnifications: 2×. Scale bars represent 2 mm. Their corresponding expanded view of the inner (B), middle (C), and outer (D) layers was captured at a 20× magnification, with scale bars set at 200 μm. The polarized light images, along with their corresponding brightfield counterparts, were captured at 20× with 200 μm scale bars.

FIG. 13 shows representative histological images of whole menisci in sagittal sections of the posterior region. (A) Representative images stained with H&E, Safranin O, and Sirius red, exhibiting the whole sagittal sections of the posterior region across various groups: fresh, slow-frozen (SF), 2-hour vitrified (2 Hr Vit), and 3-hour vitrified (3 Hr Vit). Magnifications: 2×. Scale bars represent 2 mm. Their corresponding expanded view of the inner (B), middle (C), and outer (D) layers was captured at a 20× magnification, with scale bars set at 200 μm. The polarized light images, along with their corresponding brightfield counterparts, were captured at 20× with 200 μm scale bars.

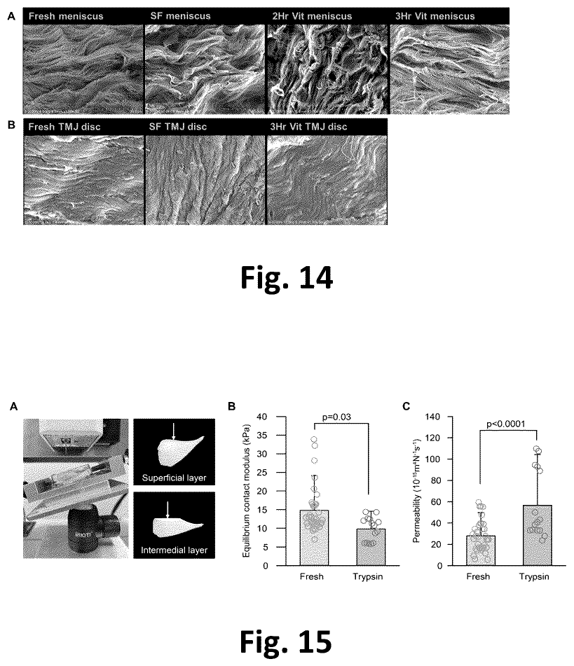

FIG. 14 shows representative SEM images of collagen fiber structures in whole knee menisci and TMJ discs. (A) Representative images exhibiting the transverse sections of the anterior horn region across various whole knee meniscus groups: fresh, slow-frozen (SF), 2-hour vitrified (2 Hr Vit), and 3-hour vitrified (3 Hr Vit). (B) Representative images exhibiting the sagittal sections of the central region across various whole TMJ disc groups: fresh, slow-frozen (SF), and 3-hour vitrified (3 Hr Vit). Magnification: 1500×.

FIG. 15 shows mechanical microindentation testing setup and comparison between fresh and trypsin-treated tissue groups. (A) Mechanical microindentation testing setup: Each sample was immersed in PBS solution and the holder was aligned to ensure that the indent tip was perpendicular to the surface being indented (left). The testing procedure involved the initial assessment of the meniscus's superficial layer (right upper), followed by shaving of the sample for subsequent testing along the intermediate layer (right lower). (B) Comparison between fresh and trypsin treated TMJ disc groups (n=15). p-value determined with a two-sided t-test. Data presented as the mean±SD.

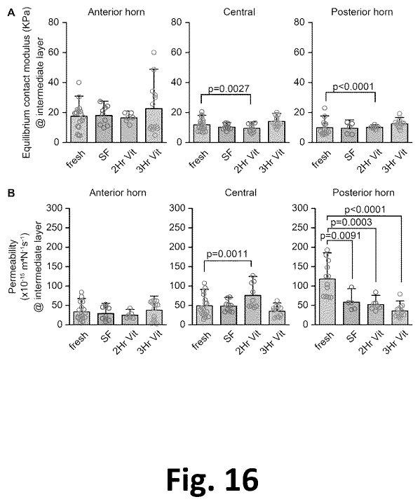

FIG. 16 shows mechanical properties of the intermediate layer in three regions of whole menisci among different groups. Results of equilibrium contact modulus (A) and permeability (B) for fresh menisci (N=6; n≥14), slow-frozen menisci (N=3; n≥5), 2-hour vitrified menisci (N=3; n≥6), and 3-hour vitrified menisci (N=5; n≥12), obtained through microindentation tests. p-value was determined with a two-sided t-test. Data presented as the mean±standard deviation. N=number of independent menisci; n=number of measurements of all samples in each region.

TABLE 1
Cooling and warming rates of different tissues.

| | Total | Cooling rate (° C./min) | | Warming rate (° C./min) | |
|---|---|---|---|---|---|
| Tissue type | volume | >−100° C. | <−100° C. | <−90° C. | −90° C. ~−35° C. |
| Meniscal | 4 ml | 26.5 ± 0.6 | 3.7 ± 0.4 | 62.1 ± 4.3 | |
| specimens | | | | | |
| Whole meniscus | 10 ml | 12.3 ± 0.9 | 4.2 ± 0.5 | 18.6 ± 1.8 | 53.9 ± 4.4 |
| Whole TMJ disc | 15 ml | 9.2 ± 0.3 | 2.4 ± 0.4 | 13.9 ± 1.1 | 30.1 ± 4.4 |

| | |
|---|---|
| T_{g} (VS55/S/T): −115.9 ± 0.2 ° C. | T_{g} (VS55): −121.2 ± 0.4 ° C. |
| T_{c} (VS55): −50.9 ± 2.1 ° C. | Tₘ (VS55): −41.6 ± 0.2 ° C. |

TABLE 2
μCT calibration curves of meniscal and TMJ disc tissues equilibrated
in VS55 solutions.

| FIG. 3A | Calibration curve of meniscal specimens saturated in VS55 solutions | | | | |
|---|---|---|---|---|---|
| VS55 | 0% | 25% | 50% | 75% | 100% |
| concentration | | | | | |
| (%) | | | | | |
| HU value | 48.6 ± 9.2 | 139.6 ± 9.8 | 211.6 ± 7.5 | 282.4 ± 14.1 | 365.1 ± 13.9 |
| FIG. S2 | μCT calibration curves of TMJ discs equilibrated in VS55 solutions | | | | |
| | Anterior | | | | |
| VS55 | 0% | 25% | 50% | 75% | 100% |
| concentration | | | | | |
| (%) | | | | | |
| HU value | 55.4 ± 24.5 | 143.8 ± 9.1 | 185.3 ± 17.8 | 232.3 ± 17.5 | 294.2 ± 10.1 |
| | Central | | | | |
| VS55 | 0% | 25% | 50% | 75% | 100% |
| concentration | | | | | |
| (%) | | | | | |
| HU value | 61.4 ± 5.4 | 138.4 ± 9.9 | 194.3 ± 15.6 | 246.1 ± 12.0 | 300.2 ± 18.2 |
| | Posterior | | | | |
| VS55 | 0% | 25% | 50% | 75% | 100% |
| concentration | | | | | |
| (%) | | | | | |
| HU value | 63.2 ± 14.4 | 140.2 ± 13.3 | 205.8 ± 4.8 | 249.7 ± 18.5 | 295.4 ± 9.9 |
| | Medial | | | | |
| VS55 | 0% | 25% | 50% | 75% | 100% |
| concentration | | | | | |
| (%) | | | | | |
| HU value | 61.4± 23.0 | 145.6 ± 9.3 | 193.1 ± 17.2 | 241.9 ± 9.0 | 291.8 ± 16.2 |
| | Lateral | | | | |
| VS55 | 0% | 25% | 50% | 75% | 100% |
| concentration | | | | | |
| (%) | | | | | |
| HU value | 48.7 ± 19.5 | 147.4 ± 6.8 | 202.2 ± 4.8 | 240.7 ± 15.1 | 296.0 ± 11.0 |

TABLE 3
CPA diffusivities in meniscal tissues obtained from this study
compared with those from prior literature.

| | | Temper- | | |
|---|---|---|---|---|
| CPA | Tissue type | ature | D (× 10⁻¹⁰ m²/s) | Reference |
| VS55 (8.4M) | Porcine | 0° C. | 3.82 ± 0.68 | This study |
| | meniscus | 22° C. | 4.98 ± 0.91 | |
| 3.1M Me₂SO | Articular | | 4.63 ± 0.85 | [4] |
| 3.1M PG | cartilage of | 22° C. | 3.47 ± 0.67 | |
| 2.2M formamide | calves | | 6.67 ± 0.70 | |
| 6.5M Me₂SO | Porcine articular | 4° C. | 2.4 | [5] |
| | cartilage | 22° C. | 3.0 | |
| | | 37° C. | 4.5 | |
| 6.5M PG | | 4° C. | 0.9 | |
| | | 22° C. | 1.6 | |
| | | 37° C. | 2.2 | |
| 14M Me₂SO | Human articular | 4° C. | 3.1 | [6] |
| | cartilage | 27° C. | 6.8 | |
| 1.4M Me₂SO | | 4° C. | 6.1 | |
| | | 27° C. | 14.4 | |
| 1.4M Me₂SO | Tissue- | 20° C. | 2.4 | [7] |
| | engineered | | | |
| | collagen | | | |
| | scaffold | | | |
| DP6 | Porcine arteries | 0-4° C. | 0.64 ± 0.02 | [8] |
| VS55 | | 0-4° C. | 0.70 ± 0.03 | |
| M22 | | 0-4° C. | 0.67 ± 0.03 | |
| VS55 | Porcine arteries | 20° C. | 1.9 | [9] |

TABLE 4
The lowest VS55 concentrations in five regions of TMJ
discs after the 3-hour loading.

| | VS55 concentrations of TMJ discs after the 3-hour loading | | | | | |
|---|---|---|---|---|---|---|
| FIG. 4E | | | | | | Whole disc |
| Region | Anterior | Central | Posterior | Medial | Lateral | average |
| VS55 | 77.5 ± 11.1 | 70.6 ± 8.1 | 77.6 ± 8.3 | 78.6 ± 6.8 | 74.5 ± 9.5 | 75.8 ± 9.0 |
| concen- | | | | | | |
| tration | | | | | | |
| (%) | | | | | | |

TABLE 5
Viability data

| FIG. 2B | Quantitative analysis of 3.5 mm thick meniscal specimens | | | | |
|---|---|---|---|---|---|
| Group | Fresh | SF | 1.5 Hr Vit | 3 Hr CPA | 3 Hr Vit |
| Viability (%) | 97.7 ± 2.1 | 23.9 ± 4.8 | 25.1 ± 7.7 | 93.1 ± 1.2 | 85.8 ± 5.5 |
| FIG. 2C | Metabolic activity of 3.5 mm thick meniscal specimens | | | | |
| Group | 3.5 mm/Fresh | | | | |
| Time | Day 0 | Day 1 | Day 2 | Day 3 | Day 4 |
| Viability (%) | 100.0 ± 44.3 | 135.1 ± 36.7 | 142.1 ± 47.2 | 156.4 ± 47.6 | 136.0 ± 36.3 |
| Group | 1 mm/1.5 HR Vit | | | | |
| Time | Day 0 | Day 1 | Day 2 | Day 3 | Day 4 |
| Viability (%) | 60.3 ± 18.2 | 84.8 ± 19.5 | 89.3 ± 20.5 | 84.3 ± 23.6 | 111.0 ± 22.2 |
| Group | 3.5 mm/SF | | | | |
| Time | Day 0 | Day 1 | Day 2 | Day 3 | Day 4 |
| Viability (%) | 47.0 ± 16.4 | 43.0 ± 21.0 | 39.0 ± 19.8 | 39.5 ± 16.3 | 52.6 ± 14.5 |
| Group | 3.5 mm/1.5 Hr Vit | | | | |
| Time | Day 0 | Day 1 | Day 2 | Day 3 | Day 4 |
| Viability (%) | 40.9 ± 7.8 | 47.3 ± 13.4 | 46.1 ± 12.5 | 38.7 ± 10.2 | 47.6 ± 8.1 |
| Group | 3.5 mm/3 Hr Vit | | | | |
| Time | Day 0 | Day 1 | Day 2 | Day 3 | Day 4 |
| Viability (%) | 55.6 ± 9.9 | 78.3 ± 14.8 | 87.2 ± 17.3 | 95.5 ± 18.9 | 101.0 ± 19.4 |
| FIG. 5B | Quantitative analysis of whole menisci | | | | |
| Group | Fresh | | | | |
| Region | Anterior | Central | | Posterior | |
| Viability (%) | 92.3 ± 3.8 | 90.9 ± 6.1 | | 91.7 ± 4.5 | |
| Group | SF | | | | |
| Region | Anterior | Central | | Posterior | |
| Viability (%) | 19.5 ± 9.6 | 23.7 ± 6.4 | | 21.4 ± 18.2 | |
| Group | 2 Hr Vit | | | | |
| Region | Anterior | Central | | Posterior | |
| Viability (%) | 49.7 ± 20.0 | 38.5 ± 23.0 | | 32.6 ± 29.1 | |
| Group | 3 Hr Vit | | | | |
| Region | Anterior | Central | | Posterior | |
| Viability (%) | 73.7 ± 10.1 | 75.0 ± 2.8 | | 71.8 ± 14.1 | |
| FIG. 5C | Quantitative analysis of whole menisci | | | | |
| Group | fresh | | | | |
| Layer | Outer | Middle | | Inner | |
| Viability (%) | 89.0 ± 8.8 | 92.6 ± 6.1 | | 92.6 ± 4.7 | |
| Group | SF | | | | |
| Layer | Outer | Middle | | Inner | |
| Viability (%) | 24.6 ± 16.9 | 20.8 ± 8.9 | | 20.3 ± 13.8 | |
| Group | 2 Hr Vit | | | | |
| Layer | Outer | Middle | | Inner | |
| Viability (%) | 36.8 ± 21.2 | 34.7 ± 22.3 | | 58.2 ± 12.8 | |
| Group | 3 Hr Vit | | | | |
| Layer | Outer | Middle | | Inner | |
| Viability (%) | 68.5 ± 6.4 | 75.1 ± 2.8 | | 79.4 ± 14.7 | |
| FIG. 5D | Metabolic activity of whole menisci | | | | |
| Group | Fresh | | | | |
| Time | Day 0 | Day 1 | Day 2 | Day 3 | Day 4 |
| Viability (%) | 100.0 ± 17.3 | 165.5 ± 46.1 | 155.9 ± 36.8 | 151.6 ± 39.5 | 193.8 ± 48.6 |
| Group | Anterior: SF | | | | |
| Time | Day 0 | Day 1 | Day 2 | Day 3 | Day 4 |
| Viability (%) | 32.9 ± 11.1 | 39.7 ± 10.1 | 31.4 ± 7.8 | 34.0 ± 6.9 | 36.7 ± 7.5 |
| Group | Anterior: 2 Hr Vit | | | | |
| Time | Day 0 | Day 1 | Day 2 | Day 3 | Day 4 |
| Viability (%) | 14.1 ± 8.6 | 21.6 ± 10.8 | 23.5 ± 11.9 | 22.0 ± 12.6 | 16.0 ± 9.2 |
| Group | Anterior: 3 Hr Vit | | | | |
| Time | Day 0 | Day 1 | Day 2 | Day 3 | Day 4 |
| Viability (%) | 63.0 ± 20.7 | 84.2 ± 32.2 | 93.9 ± 31.5 | 70.1 ± 23.1 | 73.7 ± 36.4 |
| Group | Central: SF | | | | |
| Time | Day 0 | Day 1 | Day 2 | Day 3 | Day 4 |
| Viability (%) | 43.1 ± 13.8 | 55.4 ± 16.8 | 35.1 ± 11.4 | 37.3 ± 9.6 | 35.3 ± 11.4 |
| Group | Central: 2 Hr Vit | | | | |
| Time | Day 0 | Day 1 | Day 2 | Day 3 | Day 4 |
| Viability (%) | 16.5 ± 7.5 | 22.7 ± 10.9 | 22.5 ± 12.1 | 20.1 ± 11.5 | 13.8 ± 9.8 |
| Group | Central: 3 Hr Vit | | | | |
| Time | Day 0 | Day 1 | Day 2 | Day 3 | Day 4 |
| Viability (%) | 59.2 ± 15.3 | 74.3 ± 16.7 | 80.2 ± 18.7 | 62.5 ± 16.2 | 61.3 ± 22.7 |
| Group | Posterior: SF | | | | |
| Time | Day 0 | Day 1 | Day 2 | Day 3 | Day 4 |
| Viability (%) | 38.0 ± 9.3 | 47.1 ± 7.2 | 34.9 ± 7.3 | 42.4 ± 7.4 | 45.7 ± 13.5 |
| Group | Posterior: 2 Hr Vit | | | | |
| Time | Day 0 | Day 1 | Day 2 | Day 3 | Day 4 |
| Viability (%) | 13.0 ± 4.3 | 20.5 ± 3.7 | 20.1 ± 6.0 | 18.6 ± 7.2 | 13.0 ± 6.9 |
| Group | Posterior: 3 Hr Vit | | | | |
| Time | Day 0 | Day 1 | Day 2 | Day 3 | Day 4 |
| Viability (%) | 70.6 ± 27.6 | 82.4 ± 18.3 | 90.6 ± 37.6 | 72.6 ± 33.2 | 85.1 ± 42.4 |
| FIG. 6B | Quantitative analysis of whole TMJ discs | | | | |
| Group | Fresh | | | | |
| Region | Anterior | Central | Posterior | Medial | Lateral |
| Viability (%) | 92.4 ± 1.3 | 94.0 ± 3.5 | 93.0 ± 2.9 | 90.5 ± 0.3 | 92.9 ± 3.5 |
| Group | Slow-frozen | | | | |
| Region | Anterior | Central | Posterior | Medial | Lateral |
| Viability (%) | 37.4 ± 2.7 | 40.1 ± 4.2 | 37.1 ± 2.2 | 38.3 ± 3.5 | 39.0 ± 2.7 |
| Group | 3-hour vitrified | | | | |
| Region | Anterior | Central | Posterior | Medial | Lateral |
| Viability (%) | 83.3 ± 4.1 | 87.5 ± 3.4 | 84.0 ± 4.1 | 82.4 ±3.7 | 84.2 ± 5.0 |
| FIG. 6C | Metabolic activity of whole TMJ discs | | | | |
| Group | Fresh | | | | |
| Time | Day 0 | Day 1 | Day 2 | Day 3 | Day 4 |
| Viability (%) | 100.0 ± 1.2 | 117.3 ± 1.1 | 135.3 ± 3.2 | 136.3 ± 3.3 | 136.6 ± 3.5 |
| Group | Slow-frozen | | | | |
| Time | Day 0 | Day 1 | Day 2 | Day 3 | Day 4 |
| Viability (%) | 32.0 ± 0.8 | 33.3 ± 0.5 | 28.9 ± 0.5 | 29.1 ± 1.7 | 28.0 ± 0.6 |
| Group | 3-hour Vitrified | | | | |
| Time | Day 0 | Day 1 | Day 2 | Day 3 | Day 4 |
| Viability (%) | 57.3 ± 2.0 | 79.4 ± 1.8 | 133.0 ± 1.3 | 128.4 ± 0.6 | 128.4 ± 0.4 |

TABLE 6
Mechanical data

| FIG. 7E and F | Mechanical properties of whole menisci at superficial layer | | | |
|---|---|---|---|---|
| Region | Anterior horn | | | |
| Group | Fresh | Slow frozen | 2 Hr Vit | 3 Hr Vit |
| Equilibrium | 30.8 ± 21.5 | 36.4 ± 16.2 | 29.6 ± 4.8 | 45.9 ± 14.6 |
| contact modulus | | | | |
| (KPa) | | | | |
| Permeability (×10⁻¹⁵ | 22.2 ± 16.7 | 7.1 ± 4.1 | 10.3 ± 3.9 | 8.5 ± 6.5 |
| m⁴N⁻¹s⁻¹) | | | | |
| Region | Central | | | |
| Group | Fresh | Slow frozen | 2 Hr Vit | 3 Hr Vit |
| Equilibrium | 16.6 ± 5.0 | 19.3 ± 16.4 | 38.7 ± 16.7 | 17.9 ± 3.4 |
| contact modulus | | | | |
| (KPa) | | | | |
| Permeability (×10⁻¹⁵ | 31.3 ± 18.3 | 27.2 ± 22.5 | 6.2 ± 3.3 | 19.0 ± 7.0 |
| m⁴N⁻¹s⁻¹) | | | | |
| Region | Posterior horn | | | |
| Group | Fresh | Slow frozen | 2 Hr Vit | 3 Hr Vit |
| Equilibrium | 15.3 ± 3.8 | 29.8 ± 17.9 | 19.6 ± 12.9 | 19.4 ± 5.9 |
| contact modulus | | | | |
| (KPa) | | | | |
| Permeability (×10⁻¹⁵ | 23.4 ± 18.0 | 11.9 ± 4.3 | 23.4 ± 20.7 | 15.7 ± 6.8 |
| m⁴N⁻¹s⁻¹) | | | | |
| | Mechanical properties of whole TMJ discs | | | |
| FIG. 8E and F | Anterior | | | |
| Group | Fresh | Slow-frozen | 3-hour Vitrified | |
| Equilibrium | 14.6 ± 6.6 | 7.4 ± 1.2 | 15.0 ± 3.5 | |
| contact modulus | | | | |
| (KPa) | | | | |
| Permeability (×10⁻¹⁵ | 25.1 ± 15.3 | 49.2 ± 3.0 | 26.6 ± 9.6 | |
| m⁴N⁻¹s⁻¹) | | | | |
| | Central | | | |
| Group | Fresh | Slow-frozen | 3-hour Vitrified | |
| Equilibrium | 24.6 ± 9.9 | 18.0 ± 1.0 | 23.9 ± 4.8 | |
| contact modulus | | | | |
| (KPa) | | | | |
| Permeability (×10⁻¹⁵ | 16.2 ± 14.4 | 16.9 ± 5.7 | 13.0 ± 4.2 | |
| m⁴N⁻¹s⁻¹) | | | | |
| | Posterior | | | |
| Group | Fresh | Slow-frozen | 3-hour Vitrified | |
| Equilibrium | 13.9 ± 4.5 | 21.5 ± 4.3 | 18.1 ± 2.6 | |
| contact modulus | | | | |
| (KPa) | | | | |
| Permeability (×10⁻¹⁵ | 26.7 ± 8.1 | 12.7 ± 4.6 | 15.8 ± 3.8 | |
| m⁴N⁻¹s⁻¹) | | | | |
| | Medial | | | |
| Group | Fresh | Slow-frozen | 3-hour Vitrified | |
| Equilibrium | 17.8 ± 9.7 | 21.5 ± 11.5 | 13.3 ± 3.0 | |
| contact modulus | | | | |
| (KPa) | | | | |
| Permeability (×10⁻¹⁵ | 35.1 ± 21.6 | 13.3 ± 8.7 | 21.6 ± 11.2 | |
| m⁴N⁻¹s⁻¹) | | | | |
| | Lateral | | | |
| Group | Fresh | Slow-frozen | 3-hour Vitrified | |
| Equilibrium | 15.0 ± 4.4 | 12.5 ± 1.4 | 16.9 ± 3.7 | |
| contact modulus | | | | |
| (KPa) | | | | |
| Permeability (×10⁻¹⁵ | 25.4 ± 11.1 | 34.4 ± 7.9 | 31.7 ± 9.2 | |
| m⁴N⁻¹s⁻¹) | | | | |
| | Whole disc | | | |
| Group | Fresh | Slow-frozen | 3-hour Vitrified | |
| Equilibrium | 16.8 ± 8.1 | 17.6 ± 7.9 | 17.9 ± 5.0 | |
| contact modulus | | | | |
| (KPa) | | | | |
| Permeability (×10⁻¹⁵ | 25.7 ± 15.5 | 22.0 ± 14.7 | 22.0 ± 10.3 | |
| m⁴N⁻¹s⁻¹) | | | | |
| FIG. S7 | Comparison between fresh and trypsin treated TMJ discs | | | |
| Group | Fresh | | Trypsin | |
| Equilibrium | 16.8 ± 8.1 | | 9.8 ± 3.2 | |
| contact modulus | | | | |
| (KPa) | | | | |
| Permeability (×10⁻¹⁵ | 25.7 ± 15.5 | | 56.6 ± 31.8 | |
| m⁴N⁻¹s⁻¹) | | | | |
| FIG. S8 | Mechanical properties of whole menisci at intermedial layer | | | |
| Region | Anterior horn | | | |
| Group | Fresh | Slow frozen | 2 Hr Vit | 3 Hr Vit |
| Equilibrium | 17.4 ± 9.0 | 17.9 ± 6.4 | 16.3 ± 3.2 | 22.5 ± 17.5 |
| contact modulus | | | | |
| (KPa) | | | | |
| Permeability (×10⁻¹⁵ | 33.5 ± 22.7 | 28.8 ± 17.7 | 24.7 ± 9.9 | 37.9 ± 24.3 |
| m⁴N⁻¹s⁻¹) | | | | |
| Region | Central | | | |
| Group | Fresh | Slow frozen | 2 Hr Vit | 3 Hr Vit |
| Equilibrium | 11.8 ± 4.1 | 10.2 ± 1.9 | 9.5 ± 2.8 | 14.1 ± 3.6 |
| contact modulus | | | | |
| (KPa) | | | | |
| Permeability (×10⁻¹⁵ | 48.9 ± 28.4 | 48.2 ± 14.8 | 75.8 ± 32.6 | 34.9 ± 14.5 |
| m⁴N⁻¹s⁻¹) | | | | |
| Region | Posterior horn | | | |
| Group | Fresh | Slow frozen | 2 Hr Vit | 3 Hr Vit |
| Equilibrium | 9.8 ± 5.2 | 9.4 ± 3.8 | 10.1 ± 1.1 | 12.4 ± 2.8 |
| contact modulus | | | | |
| (KPa) | | | | |
| Permeability (×10⁻¹⁵ | 120.3 ± 47.2 | 58.1 ± 23.4 | 52.0 ± 15.9 | 35.8 ± 17.1 |
| m⁴N⁻¹s⁻¹) | | | | |

The system can include a system and method for preserving biological tissues, particularly meniscus and articular cartilage, through enhanced cryoprotectant agent (CPA) loading protocols and vitrification techniques. In some aspects, the methods may involve upscaling preservation techniques for larger tissue samples, for example, those obtained from 6-month-old Yucatan minipigs, which may present challenges due to increased tissue size and complexity. In some embodiments, a new loading protocol for the cryoprotectant agent VS55 may be employed. [Protocol description]. This protocol may significantly enhance CPA penetration which may lead to improved post-rewarming viability. For instance, when applied to meniscus samples from 6-month-old Yucatan minipigs, the new 3-hour loading protocol (referred to as 3H-1) may achieve VS55 penetration of approximately 84%-92%. This level of penetration may result in over 80% cell viability after vitrification, rewarming, and long-term storage exceeding 6 months.

In comparison, a standard 3-hour loading protocol (3H) may achieve only about 46%-58% VS55 penetration in similar tissue samples, which may result in only 30-40% cell viability after vitrification and rewarming. The improved protocol may therefore meet or exceed the clinical viability threshold of 70% required for potential transplantation applications.

In one test, the enhanced loading protocol was applied to large porcine articular cartilage tissues. When applied to cartilage samples, the new protocol may achieve over 85% VS55 penetration. In some implementations, this loading protocol may be combined with an advanced radiofrequency (RF) heating system for rewarming, which may enable viability levels exceeding 90% post-warming. In some aspects, the effectiveness of the new loading protocol may be assessed through various imaging and analytical techniques. For example, fluorescence microscopy may be used to visualize the distribution of living and dead cells within the tissue samples. Computational modeling may also be employed to predict and analyze CPA distribution patterns within the tissues.

Generally, a loading protocol for the preservation of cryogenic tissue storage involves a series of steps to prepare the tissue for freezing and storage at extremely low temperatures. These steps can include a cryoprotective agent (CPA) solution that include chemicals used to protect biological tissue from freezing damage. The concentration and type of CPA used can vary depending on the tissue type. There can also be a loading p which involves gradually introducing the CPA to the tissue. For example, a standard loading protocol might consist of a multi-step loading process, with each step lasting a predetermined number of minutes. There can also be an unloading process because after the tissue has been loaded with the CPA, the CPA it needs to be removed. This might involve a multi-step unloading process, with each step lasting a predetermined number of minutes, process with varying durations for each step. There can be a cooling period having a cooling rate which can be slow enough to allow the tissue to dehydrate but fast enough to prevent excessive dehydration damage. For example, a cooling rate of −1° C. to −3° C. per minute could be used. The system can include storage conditions which include cryogenic temperatures, that can be below −100° C., to maintain its viability over long periods.

The loading protocol for the cryoprotectant agent VS55 may involve a multi-step process designed to enhance penetration into the tissue samples. In some aspects, the protocol may include a series of concentration gradients applied over a specific time period. For example, the protocol may begin with a lower concentration of VS55 and gradually increase to higher concentrations over the course of 3 hours.

In some implementations, the protocol may involve 5 distinct loading steps. The first four steps may each last approximately 15 minutes, during which the VS55 concentration may be incrementally increased. The final step may extend for about 120 minutes, allowing for prolonged exposure to the highest concentration of VS55.

The protocol may also incorporate temperature control measures to optimize CPA penetration. For instance, the loading process may be conducted at a temperature range of 2° C. to 4° C., which may help maintain tissue integrity while facilitating CPA diffusion.

In some cases, the protocol may include gentle agitation or circulation of the CPA solution during the loading process. This may help ensure uniform distribution of the VS55 around the tissue sample and potentially enhance penetration.

The loading protocol may be adaptable based on the specific tissue type and size. For larger or denser tissues, the duration of certain steps may be extended or the concentration gradients may be adjusted to achieve optimal penetration.

In some embodiments, the protocol may incorporate additional components or pre-treatment steps to further enhance CPA penetration. For example, the use of penetration enhancers or osmotic agents may be considered in conjunction with the VS55 loading process.

The effectiveness of the loading protocol may be monitored in real-time using imaging techniques or computational modeling. This may allow for dynamic adjustments to the protocol based on observed penetration rates and patterns.

In some implementations, the system may include specialized hardware for loading tissue samples with cryoprotectant agents. This hardware may comprise a temperature-controlled chamber designed to maintain optimal conditions during the loading process. The chamber may be equipped with a programmable cooling system capable of precisely regulating temperatures between −10° C. and 37° C., allowing for fine control over the loading environment.

The loading chamber may incorporate a fluid circulation system to ensure uniform distribution of the cryoprotectant agent around the tissue sample. This system may include microfluidic channels or a perfusion apparatus that can deliver the cryoprotectant solution at controlled flow rates and pressures. In some cases, the chamber may be fitted with ultrasonic agitators to gently mix the solution and promote even penetration into the tissue.

The hardware may also feature an automated dispensing system for introducing cryoprotectant agents in a stepwise manner according to the loading protocol. This system may include multiple reservoirs for different concentrations of the cryoprotectant, connected to precision pumps that can accurately deliver specified volumes at predetermined time intervals.

In some embodiments, the loading hardware may be integrated with real-time monitoring capabilities. This may include sensors for measuring solution concentration, temperature, and pH, as well as imaging systems for visualizing cryoprotectant penetration into the tissue. The hardware may be connected to a computerized control system that can adjust loading parameters based on feedback from these monitoring systems.

The tissue loading hardware may also incorporate features to minimize contamination risks. This may include a sealed loading chamber with HEPA filtration, UV sterilization capabilities, and disposable or easily sterilizable components that come into direct contact with the tissue or cryoprotectant solutions.

The system and method can include a temperature-controlled chamber adapted to receive a tissue and a cryoprotectant agent wherein the tissue is loaded with the cryoprotectant agent according to a loading protocol; wherein the temperature-controlled chamber adapted to reducing the temperature of the loaded tissue to a predetermined low temperature; wherein the temperature controller chamber is adapted to store the tissue at the low temperature; and, wherein the temperature-controlled chamber include a warming device for warming the tissue using room temperature liquid. The system wherein the loading protocol includes a set of steps defined by each having a loading time in the range of 13 to 17 minutes. The system wherein the cryoprotectant agent in the first set of steps is in the range of 1.5 and 9.0 molarity. The system wherein the molarity of each step increases. The system wherein the set of steps is a first set of steps, the loading time is a first loading time, and the loading protocol includes a second step defined by a second loading time in the range of 100 to 140 minutes. The system includes a set of unloading steps defined by each having an unloading time in the range of 13 to 17 minutes. The system wherein the set of unloading steps is a first set of unloading steps, the unloading time is a first unloading time and a second set of unloading steps defined by each having a second loading time in the range of 50 to 70 minutes. The system wherein the cryoprotectant agent is vitrification solutions 55. The system wherein the room temperature liquid is water. The system wherein the loading protocol comprises a loading time in the range of 1 to 4 hours. The system wherein the tissue comprises a post-loading diffusion greater than about 30% in a first tissue portion and greater than 90% in a second tissue portion. The system wherein the first tissue portion is an outer layer of the tissue, and the second tissue portion is an inner layer of the tissue.

The system and method can include harvesting tissue from a donor; providing a loading protocol according to a computerized simulation for determining diffusion kinetics within the tissue; loading the tissue with a cryoprotectant agent according to the loading protocol; reducing the temperature of the loaded tissue to a predetermined low temperature; and, storing the tissue at the low temperature. The method includes retrieving the tissue from storage; and warming the tissue using room temperature liquid. The method wherein the loading protocol includes a loading time in the range of 10 to 20 minutes. The method wherein the loading protocol comprises a multi-step loading process with the first steps lasting 15 minutes or less each. The method wherein the final step lasts 120 minutes or less. The method further comprising assessing tissue viability post-warming using fluorescence microscopy. The method wherein the tissue is selected from the group consisting of meniscus tissue, articular cartilage tissue, and temporomandibular joint disc tissue. The method wherein the cryoprotectant agent is VS55. The method wherein the tissue exhibits a post-loading diffusion of the cryoprotectant agent greater than about 80% throughout the tissue.

The methods and systems described herein may provide significant advancements in tissue preservation techniques, potentially enabling the long-term storage and subsequent use of larger, more complex tissue samples for various medical and research applications. These improvements may have implications for fields such as tissue engineering, regenerative medicine, and transplantation.

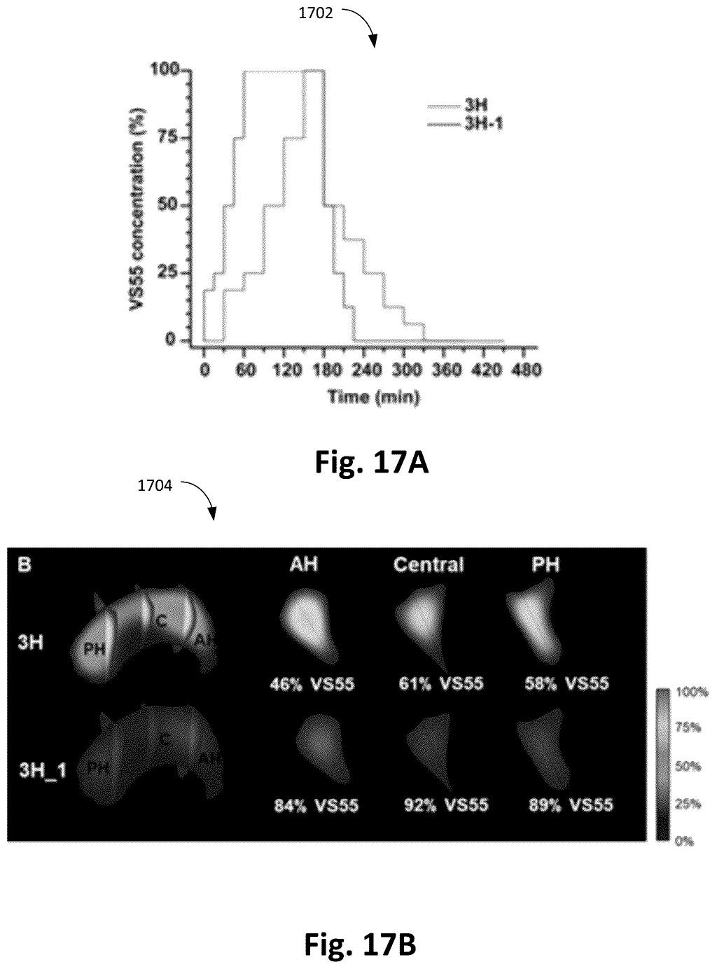

Referring to FIGS. 17A and 17B, increasing the meniscus size from 6-week-old to 6-month-old Yucatan minipigs results and using the standard 3-hour loading protocol 1702 achieved approximately 46%-58% VS55 penetration as shown in 1704, which proved insufficient, resulting in only 30-40% cell viability after vitrification and rewarming. In contrast, the newly developed 3-hour loading protocol \significantly enhanced VS55 penetration to 84%-92%, ensuring over 80% cell viability post-warming after long-term storage exceeding 6 months. This meets the clinical viability threshold (≥70%) required for transplantation. FIGS. 17A and 17B show the comparison of two 3-hour VS55 loading protocols for 6-month-old porcine menisci. FIG. 17A shows loading steps while FIG. 17B shows VS55 distribution achieved using the two protocols.

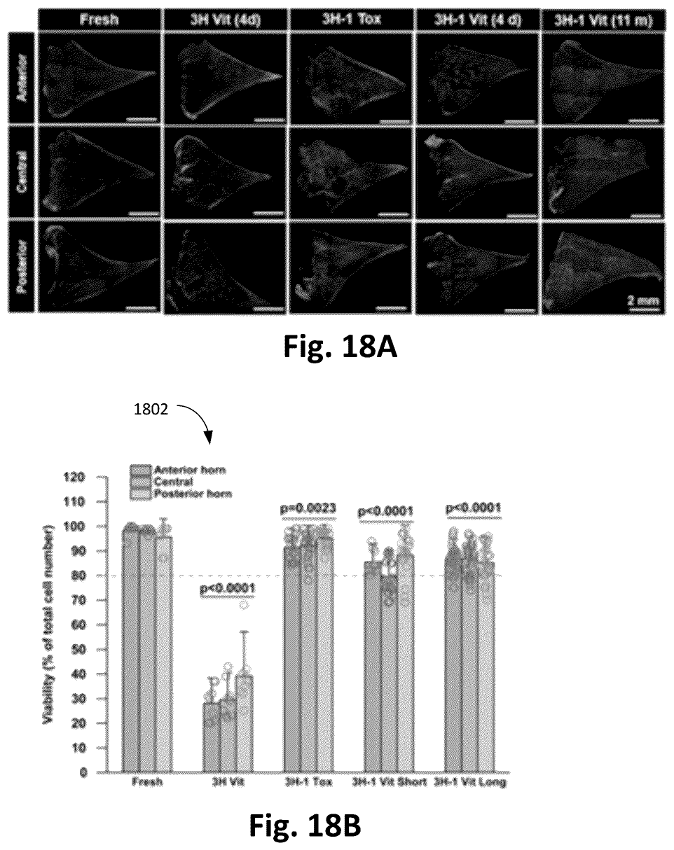

Referring to FIGS. 18A and 18B, viability comparison across five groups: fresh menisci, vitrified menisci using the standard protocol, menisci loaded and unloaded using the new protocol, and menisci vitrified using the new protocols for both short-term and long-term storage are shown. FIG. 18A shows the fluorescence live/dead images of the five groups and FIG. 18B shows the quantitative analysis of fluorescence live/dead images from the five groups 1802.

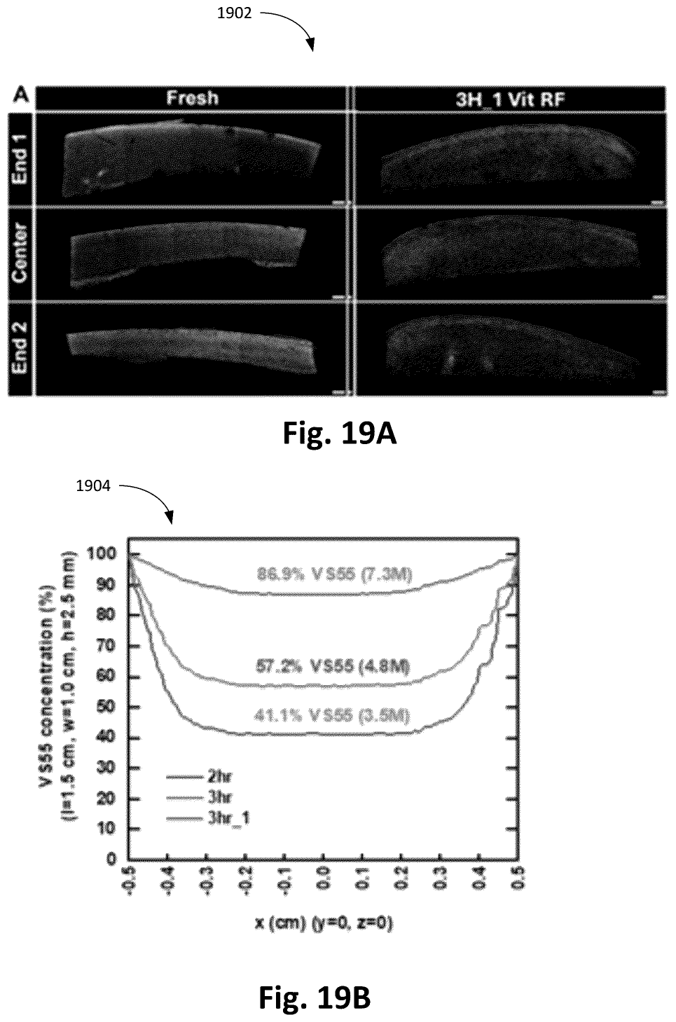

This system can also be applied to large porcine articular cartilage tissues to achieve sufficient CPA penetration for vitrification and warming. The loading protocol 1904 (the same loading steps used for meniscus) has achieved over 85% VS55 penetration as shown in FIG. 19B. When combined with the advanced radiofrequency (RF) heating system, it enables viability levels exceeding 90% post-warming as shown in FIG. 19A. FIG. 19A shows the viability of vitrified cartilage using the loading protocols compared to fresh tissues 1902 and FIG. 19B shows VS55 concentration profiles in cartilage tissues using different loading protocols.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A system for preservation of tissue, comprising:
a temperature-controlled chamber adapted to receive a tissue and a cryoprotectant agent wherein the tissue is loaded with the cryoprotectant agent according to a loading protocol;
wherein the temperature-controlled chamber adapted to reducing the temperature of the loaded tissue to a predetermined low temperature;
wherein the temperature controller chamber is adapted to store the tissue at the low temperature; and,
wherein the temperature-controlled chamber include a warming device for warming the tissue using room temperature liquid.

2. The system of claim 1 wherein the loading protocol includes a set of steps defined by each having a loading time in the range of 13 to 17 minutes.

3. The system of claim 2 wherein the cryoprotectant agent in the first set of steps is in the range of 1.5 and 9.0 molarity.

4. The system of claim 3 wherein the molarity of each step increases.

5. The system of claim 3 wherein the set of steps is a first set of steps, the loading time is a first loading time, and the loading protocol includes a second step defined by a second loading time in the range of 100 to 140 minutes.

6. The system of claim 5 includes a set of unloading steps defined by each having an unloading time in the range of 13 to 17 minutes.

7. The system of claim 6 wherein the set of unloading steps is a first set of unloading steps, the unloading time is a first unloading time and a second set of unloading steps defined by each having a second loading time in the range of 50 to 70 minutes.

8. The system of claim 1 wherein the cryoprotectant agent is vitrification solutions 55.

9. The system of claim 1, wherein the room temperature liquid is water.

10. The system of claim 1, wherein the loading protocol comprises a loading time in the range of 1 to 4 hours.

11. The system of claim 1, wherein the tissue comprises a post-loading diffusion greater than about 30% in a first tissue portion and greater than 90% in a second tissue portion.

12. The system of claim 11, wherein the first tissue portion is an outer layer of the tissue, and the second tissue portion is an inner layer of the tissue.

13. A method for preservation of tissue, comprising:
harvesting tissue from a donor;
providing a loading protocol according to a computerized simulation for determining diffusion kinetics within the tissue;
loading the tissue with a cryoprotectant agent according to the loading protocol;
reducing the temperature of the loaded tissue to a predetermined low temperature; and,
storing the tissue at the low temperature.

14. The method of claim 13 includes retrieving the tissue from storage; and
warming the tissue using room temperature liquid.

15. The method of claim 14, wherein the loading protocol includes a loading time in the range of 10 to 20 minutes.

16. The method of claim 15, wherein the loading protocol comprises a multi-step loading process with the first steps lasting 15 minutes or less each

17. The method of claim 16 wherein the final step lasts 120 minutes or less.

18. The method of claim 13, further comprising assessing tissue viability post-warming using fluorescence microscopy.

19. The method of claim 13, wherein the tissue is selected from the group consisting of meniscus tissue, articular cartilage tissue, and temporomandibular joint disc tissue.

20. The method of claim 13, wherein the tissue exhibits a post-loading diffusion of the cryoprotectant agent greater than about 80% throughout the tissue.
